(19) United States
(12) Patent Application Publication
(10) Pub. No.: US 2026/0235764 A1
(43) Pub. Date: Aug. 13, 2026

(54) LIDAR-BASED CONTINUOUS EGOMOTION

(71) Applicant: Mobileye Vision Technologies Ltd., Jerusalem (IL)

(72) Inventor: Yotam STERN, Jerusalem (IL)

(21) Appl. No.: 19/537,617

(22) Filed: Feb. 12, 2026

(30) Foreign Application Priority Data
Feb. 12, 2025 (DE) 102025105081.3

(51) Int. Cl. G01S 17/931; G01S 17/89; G06T 7/30; G06V 20/64

(52) U.S. Cl. CPC G01S 17/931; G01S 17/89; G06T 7/30; G06V 20/64

(57) ABSTRACT

The present disclosure relates to an apparatus for processing data from a LIDAR sensor, the apparatus including a processor configured to: obtain a LIDAR map, wherein the LIDAR map includes an aggregation of a plurality of LIDAR scans from a LIDAR sensor; obtain an additional first LIDAR scan from the LIDAR sensor, wherein the first LIDAR scan includes a plurality of first data points; obtain pose information representative of each of a plurality of poses of the LIDAR sensor during the first LIDAR scan; and determine a rigid transformation to map each of the plurality of first data points onto the LIDAR map based on at least two adjacent poses of the plurality of poses.

### CROSS-REFERENCE TO RELATED APPLICATION

This application claims priority to German Patent Application Serial No. 10 2025 105 081.3, which was filed Feb. 12, 2025, and is incorporated herein by reference in its entirety.

### TECHNICAL FIELD

The present disclosure is generally related to an apparatus for processing data from a Light Detection and Ranging (LIDAR) sensor, and to a corresponding method of processing data from a LIDAR sensor.

### BACKGROUND

In general, LIDAR is a remote sensing technology based on the emission and detection of light signals for measuring distances and obtaining three-dimensional information about a scene, e.g., about objects and surfaces present in the scene. In view of their advantageous properties, such as high resolution, rapid detection, and compact dimensions, LIDAR sensors are adopted for many different applications, e.g., in the context of autonomous driving, autonomous robots, geospatial mapping, presence detection, and the like. Various algorithms have been developed to process the information collected by a LIDAR sensor and provide a three-dimensional understanding of a scene. Improvements in strategies for an efficient and accurate processing of LIDAR data are thus of interest for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A to FIG. 1C show exemplary flow diagrams of different approaches for processing LIDAR data;

FIG. 2A shows an apparatus for processing data from a LIDAR sensor, in a schematic representation according to various aspects;

FIG. 2B shows an exemplary LIDAR scan, according to various aspects;

FIG. 3A shows a further configuration of the apparatus for processing data from a LIDAR sensor, in a schematic representation according to various aspects;

FIG. 3B shows a pre-processing of a LIDAR scan, according to various aspects;

FIG. 4A shows a further configuration of the apparatus for processing data from a LIDAR sensor, in a schematic representation according to various aspects;

FIG. 4B shows a graph associated with the sampling of the pose of a LIDAR sensor, according to various aspects;

FIG. 5A shows the apparatus further including a LIDAR sensor, in a schematic representation according to various aspects;

FIG. 5B shows an exemplary configuration of the LIDAR sensor, in a schematic representation according to various aspects; and

FIG. 6A to FIG. 6C shows results of simulations of the adapted processing of the present disclosure, according to various aspects.

FIG. 7 shows a flow diagram illustrating a computerized method for aligning three-dimensional (3D) detection data according to an embodiment.

FIG. 8 shows a flow diagram illustrating an example which includes the method of FIG. 7.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a LIDAR sensor, an apparatus for processing data from a LIDAR sensor, etc.). However, it is understood that aspects described in connection with methods may similarly apply to the devices, and vice versa.

In general, LIDAR is a well-established technology in the context of distance measurements. The LIDAR technique is based on the emission and detection of a plurality of light signals (e.g., up to hundreds of thousands of light pulses per second), which allow for the mapping of the scene in the field of view of the LIDAR sensor. Processing the light signals that are reflected back towards the LIDAR sensor allows the sensor to generate a three-dimensional map of the scene, which may be used for implementing further functionalities, such as generating driving instructions for a vehicle, tracking the movement of an object, and the like.

A LIDAR sensor may scan the world around it by actively emitting a laser beam and waiting for the beam to return to the sensor. In the so-called “direct time-of-flight” approach, the round-trip time of the laser beam provides a measure of the distance between the LIDAR sensor and the object or surface that caused the back reflection of the laser beam.

A problem may occur in case the LIDAR sensor is mounted on a moving host, such as a vehicle (e.g., a car, a drone, a robot, and the like). In this scenario, the movement of the host, and the corresponding movement of the LIDAR sensor, may cause a distortion of the LIDAR scan. Illustratively, the position of the LIDAR sensor changes during the scan according to the movement of the host, thus causing a misalignment between the coordinates of the data points in the LIDAR point cloud and the corresponding real-world coordinates. The distorted real-world measurements may lead to inaccurate measurements of the objects around the host, potentially causing safety issues, e.g., in case a vehicle determines a driving trajectory based on wrong information about its surroundings as an example.

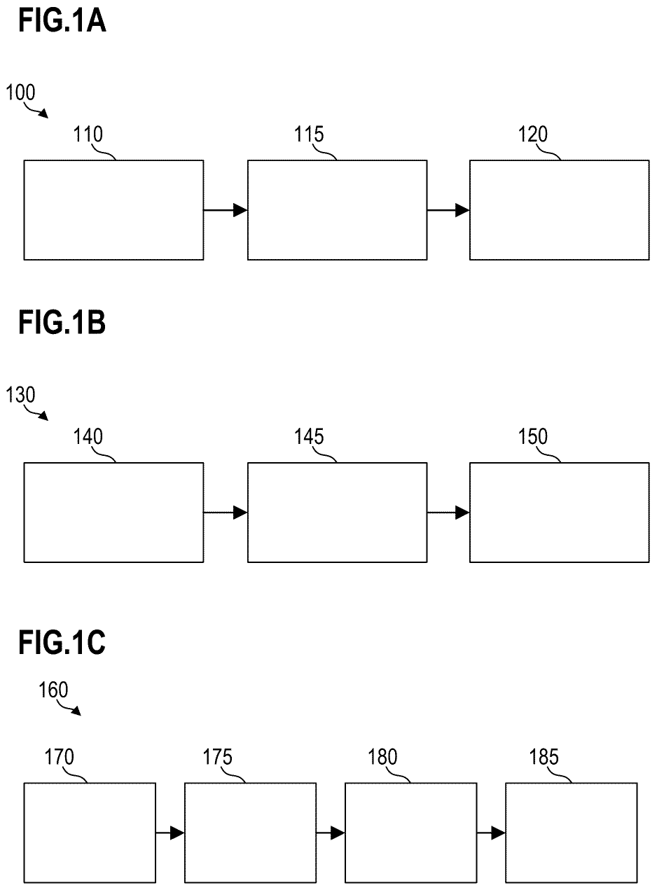

The distortion of the LIDAR scan may be compensated by knowing the egomotion of the host (e.g., of the vehicle on which the LIDAR sensor is mounted), and applying a corresponding correction to the scanned LIDAR point cloud to cancel out the distortion. Illustratively, by knowing the displacement of the host during the LIDAR scan it is possible to determine the evolution of the actual position of the LIDAR sensor during the scan, and to provide a corresponding correction of the collected data points. Various approaches exist for LIDAR egomotion, illustrated schematically in FIG. 1A to FIG. 1C.

With reference to FIG. 1A, a first method 100 may include a so-called “scan-to-scan matching” for determining the egomotion of the host and correcting the distortion of a LIDAR scan. The method 100 includes, in 110, loading and preprocessing consecutive LIDAR scans. The method 100 further includes, in 115, using an iterative closest point (ICP) algorithm to find a rigid transformation between the scans. Finally, the method 100 includes, in 120, concatenating consecutive transformations to obtain the egomotion of the host.

The ICP algorithm takes two consecutive point clouds and identifies a rigid transformation to move one cloud into the other. Illustratively, considering a first point cloud obtained at a first time point t₁, and a second point cloud obtained at a later second time point t₂, the ICP algorithm determines the rigid transformation to be applied to the data points of the first point cloud to move them onto the corresponding data points of the second point cloud. The rigid transformation provides thus an indication of the movement of the host during the time elapsed between the two scans.

The “scan-to-scan matching” takes a whole scan as a rigid measurement, and aligns the scans with one another in a concatenated fashion. Although relatively simple from a computational point of view, this approach is noisy and prone to failure. A LIDAR scan is generally sparse, so that a data point in a LIDAR scan may not have a corresponding data point in the next scan, thus leading to potential errors in the estimation of the egomotion.

An improvement of the “scan-to-scan” approach is the so-called “scan-to-map matching”, illustrated in FIG. 1B. This method 130 starts from an existing LIDAR map (illustratively, an aggregation of LIDAR scans) and includes, in 140, loading and preprocessing the next LIDAR scan. The method 130 further includes, in 145, using the ICP algorithm to find the rigid transformation between the newly loaded LIDAR scan and the existing LIDAR map. Finally, the method 130 includes, in 150, adding the new scan into the map after completion of the ICP algorithm.

The scan-to-map is a more accurate approach compared to the scan-to-scan of FIG. 1A, as each scan is matched not just to another scan but to an aggregation of multiple scans, which thus provide a denser point cloud reducing the possibility of failures. Illustratively, the method relies on the aggregation of matched scans into an incrementally growing map. However, also the scan-to-map approach is prone to errors due to the distortions of the individual LIDAR scans caused by the host movement during the point cloud sampling. The distortions lead to a noisy map and to drifts if the alignment of the scan to the map is carried out without rectifying the measurement.

An improvement of the scan-to-map approach includes the use of additional sensors to undistort the scans, as illustrated in FIG. 1C. Also in this scenario, the method 160 starts from an existing LIDAR map, and includes, in 170, loading and preprocessing the next LIDAR scan. The method 160 further includes, in 175, undistorting the newly loaded scan using data from additional sensors, e.g., data from an odometer and/or from an inertial measurement unit (IMU). The method 160 further includes, in 180, using the ICP algorithm to find the rigid transformation between the newly loaded and undistorted LIDAR scan and the existing LIDAR map. Finally, the method 160 includes, in 185, adding the new undistorted scan into the map after completion of the ICP algorithm.

The approach of FIG. 1C may be understood as a fusion of LIDAR and IMU, which makes use of inertial measurement sensors that are good for tracking movement and rotation in short time. The IMU is used to rectify the point cloud for the single cycle, enhancing the accuracy of the ICP algorithm. However, integrating over long time periods causes bias and drift. Furthermore, the use of additional sensors introduces further issues, such as the need for calibration, the need for synchronization, increased costs, increased complexity, and the like. This approach may also be not accurate enough on high frequency movements, for instance if the car on which the LIDAR sensor is mounted encounters a pot hole or a speed bump.

Existing approaches to the “egomotion problem” in the LIDAR context present thus various shortcomings. For example, the fusion of a LIDAR sensor with IMU data relies on additional sensors and calibration, thus increasing the system cost, and adding additional calibration requirements to the setup. On the other hand, approaches that rely only on the LIDAR sensor to try to correct the distortion of a single LIDAR cycle may produce problematic egomotion results which are not continuous between consecutive cycles. As a further consideration, existing solutions produce egomotion in the frequency of the LIDAR sensor itself (typically 10 Hz) which is not very high, and may thus suffer from distortions at very high frequency motion of the host.

Aspects of the present disclosure are related to an adapted approach to LIDAR egomotion, aimed at overcoming at least some of the shortcomings of conventional solutions. In particular, the present disclosure is based on the realization that a LIDAR scan should not be considered as a single rigid measurement, but rather the approach proposed herein takes into account changes in the pose of the LIDAR sensor during the LIDAR scan, thus allowing a more accurate projection of the LIDAR scan onto an existing LIDAR map.

Illustratively, the processing strategy proposed herein is based on estimating the actual pose of the LIDAR sensor at the time of scanning and recording each data point in the LIDAR scan. In this way, each data point may be mapped onto the existing LIDAR map while adjusting for variations in the position of the LIDAR sensor that occur during the scan. The adjustment leads to an accurate mapping even in presence of violent events for the host on which the LIDAR sensor is mounted, e.g., an abrupt turn, a speed bump, a pothole, and the like. The approach of the present disclosure therefore allows for the following of high frequency variations in the position of the host during a LIDAR scan, and may be referred to as “continuous high frequency (HF) LIDAR egomotion”.

The processing proposed herein may include a sampling of the pose of the LIDAR sensor at multiple time points during the LIDAR scan, and an estimation of the pose at the time of recording of each data point based on an interpolation of the sampled poses (e.g., of at least two of the sampled poses). The sampling frequency for sampling the poses is greater than the scan frequency of the LIDAR sensor, so that for each scan multiple poses are evaluated, e.g., at least two poses, or preferably more than two poses per scan. In some aspects, the sampling frequency may be dynamically adapted, for example in case particularly rough conditions for the movement of the host are detected or expected, e.g., if a navigation system of the vehicle indicates a rough terrain ahead, a turbulence, and the like.

By way of illustration, the approach of the present disclosure may be understood as a further evolution of the scan-to-map approach of FIG. 1B and of the LIDAR-IMU-fusion of FIG. 1C, wherein finding the rigid transformation between the new scan and the existing map does not rely merely on the LIDAR scan “as is”, but further includes an adjustment of the coordinates of the data points based on the estimated pose of the LIDAR sensor. The adapted processing allows for the development of accurate ground truth data to train and improve online algorithms, thereby unlocking the full potential of a LIDAR sensor, and avoiding false detection that may arise from aggregating LIDAR scans with inferior egomotion.

According to various aspects, a method of processing data from a LIDAR sensor includes: obtaining a LIDAR map, wherein the LIDAR map includes an aggregation of a plurality of LIDAR scans from a LIDAR sensor; obtaining an additional (first) LIDAR scan from the LIDAR sensor (illustratively, a scan that is not yet part of the LIDAR map, e.g., a scan that temporally follows the previous aggregated scans), wherein the first LIDAR scan includes a plurality of first data points; obtaining (first) pose information representative of each of a plurality of poses of the LIDAR sensor during the first LIDAR scan; and determining a rigid transformation to map each of the plurality of first data points onto the LIDAR map based on at least two (temporally) adjacent poses of the plurality of poses, wherein determining the rigid transformation includes, for each first data point of the plurality of first data points, determining (e.g., based on the pose information) a respective pose of the LIDAR sensor at the time of recording that first data point. The method described in this paragraph provides a first example.

The method may optionally include that determining the rigid transformation includes, for each first data point of the plurality of first data points, projecting that first data point onto the LIDAR map using the respective pose of the LIDAR sensor at the time of recording that first data point. The features of this paragraph in combination with the first example provide a second example. Projecting a data point taking into account the estimated (actual) pose of the LIDAR sensor enhances the accuracy of determining the rigid transformation for the mapping.

The method may optionally include that obtaining the (first) pose information includes sampling the pose of the LIDAR sensor at a plurality of sampling times within the first LIDAR scan. The features of this paragraph in combination with the first example or the second example provide a third example.

The method may optionally include that sampling the pose of the LIDAR sensor includes determining the pose of the LIDAR sensor based on the first data points recorded before and/or after the sampling time of the pose. The features of this paragraph in combination with the third example provide a fourth example. Illustratively, the pose of the LIDAR sensor at a certain time point may be determined using the result of the LIDAR scan, thus providing an estimation of the pose that takes into close consideration the actual behavior of the LIDAR sensor rather than relying on previous assumptions.

The method may optionally include that, for each first data point of the plurality of first data points, determining the pose of the LIDAR sensor at the time of recording that first data point includes: interpolating a first pose sampled at a first sampling time before the time of recording of that first data point with a second pose sampled at a second sampling time after the time of recording of that first data point. The features of this paragraph in combination with the third example or the fourth example provide a fifth example.

The method may optionally include that the interpolating the first pose with the second pose includes carrying out a Spherical Linear Interpolation, SLERP, of the first pose with the second pose. The features of this paragraph in combination with the fifth example provide a sixth example. SLERP ensures a smooth and efficient interpolation to determine the respective pose associated with a data point.

The method may optionally include that the sampling of the pose of the LIDAR sensor has a sampling frequency greater than a scan frequency of the LIDAR sensor. The features of this paragraph in combination with any one of the examples three to six provide a seventh example. The higher sampling frequency ensures that multiple poses are evaluated for each LIDAR scan, thus leading to a more accurate determination of the transformation for projecting the scan onto the map.

The method may optionally include that the sampling times for sampling the pose of the LIDAR sensor are distributed at regularly spaced time intervals during the first LIDAR scan. The features of this paragraph in combination with any one of the examples three to seven provide an eighth example. The regular distribution of the sampling times may enhance the robustness and reproducibility of the processing.

The method may optionally include, prior to determining the rigid transformation to map each of the plurality of first data points onto the LIDAR map: removing a distortion of the first data points to provide an initial alignment between the first data points and the LIDAR map. The features of this paragraph in combination with any one of the examples one to eight provide a ninth example. The initial “undistortion” may further reduce the risk of drifts and biases in the measurement.

The method may optionally include that removing the distortion of the first data points is based on motion data from a motion sensor recorded during the first LIDAR scan. The features of this paragraph in combination with the ninth example provide a tenth example. Illustratively, the method may optionally rely on additional sensors (e.g., an inertial measurement sensor, an odometer) to add a further degree of robustness to the measurement by providing an assessment based on additional data that are independent of the LIDAR sensor.

The method may optionally include that determining the rigid transformation includes carrying out an iterative closest point algorithm to map each first data point onto the LIDAR map. The features of this paragraph in combination with any one of the examples one to ten provide an eleventh example. The ICP algorithm provides a simple, yet efficient solution for aligning the data points of the (first) LIDAR scan to the data points of the LIDAR map.

The method may optionally further include determining an egomotion of the LIDAR sensor based on the determined rigid transformation. The features of this paragraph in combination with any one of the examples one to eleven provide a twelfth example.

The method may optionally further include determining an egomotion of a host of the LIDAR sensor based on the determined rigid transformation. The features of this paragraph in combination with any one of the examples one to twelve provide a thirteenth example. As discussed above, the proposed approach enhances the accuracy of the determination of the egomotion, and thus allows for the taking of further action in a more precise manner, e.g., to determine more accurate instructions for controlling an operation of the host.

The method may optionally further include obtaining a plurality of LIDAR scans from the LIDAR sensor (illustratively, not yet part of the LIDAR map), the plurality of LIDAR scans including the first LIDAR scan and one or more further LIDAR scans, wherein obtaining (first) pose information includes determining at least one pose of the LIDAR sensor during the first LIDAR scan based on first data points from the first LIDAR scan and on further data points from another LIDAR scan of the plurality of LIDAR scans. The features of this paragraph in combination with any one of the examples one to thirteen provide a fourteenth example. Illustratively, the optimization may be carried out on multiple LIDAR cycles together, which allows for the minimizing of edge effects by assessing the poses of the LIDAR sensor based on data points from consecutive scans.

The method may optionally further include, after determining the rigid transformation to map each of the plurality of first data points onto the LIDAR map: adding the first LIDAR scan to the LIDAR map to provide an updated LIDAR map. The features of this paragraph in combination with any one of the examples one to fourteen provide a fifteenth example. The LIDAR map may thus constantly grow with the addition of further LIDAR scans, which enhances the accuracy of future measurements and reduces the probability of failures (e.g., of missing data points).

The method may optionally further include, obtaining an additional second LIDAR scan from the LIDAR sensor (illustratively, a further scan not yet part of the map, e.g., at a later time point with respect to the first LIDAR scan), wherein the second LIDAR scan includes a plurality of second data points; obtaining second pose information representative of each of a plurality of second poses of the LIDAR sensor during the second LIDAR scan; and determining a (second) rigid transformation to map each of the plurality of second data points onto the updated LIDAR map based on at least two (temporally) adjacent poses of the plurality of second poses, wherein determining the rigid transformation includes, for each second data point of the plurality of second data points, determining a pose of the LIDAR sensor at the time of recording the second data point. The features of this paragraph in combination with the fifteenth example provide a sixteenth example. Illustratively, the proposed approach may be iteratively repeated to assess further scans to be added to the existing map, which is adapted using the accurate mapping proposed herein.

The method may optionally further include that obtaining the second pose information includes sampling the pose of the LIDAR sensor at a plurality of second sampling times during the second LIDAR scan, and that the sampling of the pose of the LIDAR sensor during the second LIDAR scan has a different sampling frequency with respect to the sampling of the pose of the LIDAR sensor during the first LIDAR scan. The features of this paragraph in combination with the sixteenth example provide a seventeenth example. The dynamic adaptation of the sampling frequency allows for the adapting of the measurement to the current conditions in which the LIDAR sensor operates, e.g., the sampling frequency may be increased if rougher conditions with greater changes in the pose of the LIDAR sensor are expected, or may be decreased if more stable conditions with smaller changes in the pose are expected.

A computer program (product) may be provided, the computer program (product) including instructions which, when the program is executed by a computer, cause the computer to carry out the method of processing data from a LIDAR sensor of any one of examples one to seventeen. The features of this paragraph provide an eighteenth example.

A non-transitory computer-readable (storage) medium may be provided, the non-transitory computer-readable (storage) medium including instructions which, when executed by a computer, cause the computer to carry out the method of processing data from a LIDAR sensor of any one of examples one to seventeen. The features of this paragraph provide a nineteenth example.

According to various aspects, an apparatus for processing data from a LIDAR sensor includes a processor configured to: obtain a LIDAR map, wherein the LIDAR map includes an aggregation of a plurality of LIDAR scans from a LIDAR sensor; obtain an additional first LIDAR scan from the LIDAR sensor, wherein the first LIDAR scan includes a plurality of first data points; obtain (first) pose information representative of each of a plurality of poses of the LIDAR sensor during the first LIDAR scan; and determine a rigid transformation to map each of the plurality of first data points onto the LIDAR map based on at least two (temporally) adjacent poses of the plurality of poses, wherein to determine the rigid transformation the processor is configured to, for each first data point of the plurality of first data points, determine (e.g., based on the pose information) a respective pose of the LIDAR sensor at the time of recording that first data point. The apparatus described in this paragraph provides a twentieth example.

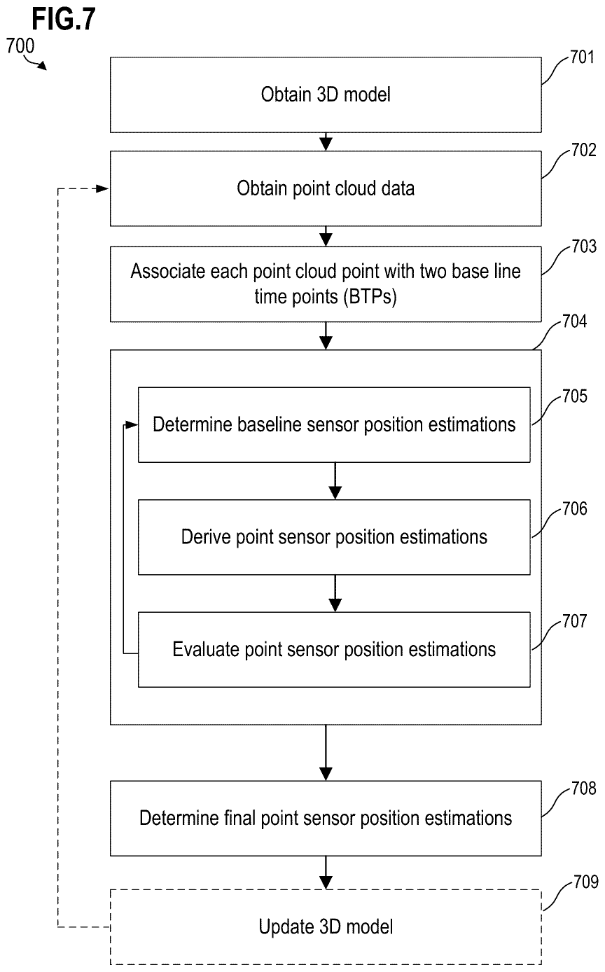

The additional first LIDAR scan for example provides the point cloud data of step 702 of the method of FIG. 7.

The plurality of poses are for example the sensor poses at the base line time points (BTPs) of the method of FIG. 7. Accordingly, mapping each of the plurality of first data points onto the LIDAR map based on at least two (temporally) adjacent poses of the plurality of poses may correspond to an interpolation of estimates of sensor poses at the BTPs (e.g. corresponding to the sensor position estimations associated with the BTPs used in step 708 of the method of FIG. 7).

The apparatus may optionally include that to determine the rigid transformation, the processor is configured to project, for each first data point of the plurality of first data points, that first data point onto the LIDAR map using the respective pose of the LIDAR sensor at the time of recording that first data point. The features of this paragraph in combination with the twentieth example provide a twenty-first example.

The apparatus may optionally include that to obtain the (first) pose information the processor is configured to sample the pose of the LIDAR sensor at a plurality of sampling times within the first LIDAR scan. The features of this paragraph in combination with the twentieth example or the twenty-first example provide a twenty-second example.

The apparatus may optionally include that to sample the pose of the LIDAR sensor the processor is configured to determine the pose of the LIDAR sensor based on the first data points recorded before and/or after the sampling time of the pose. The features of this paragraph in combination with the twenty-second example provide a twenty-third example.

The apparatus may optionally include that the processor is further configured to determine, for each first data point of the plurality of first data points, the pose of the LIDAR sensor at the time of recording of that first data point by interpolating a first pose sampled at a first sampling time before the time of recording of that first data point with a second pose sampled at a second sampling time after the time of recording of that first data point. The features of this paragraph in combination with the twenty-second example or the twenty-third example provide a twenty-fourth example.

The apparatus may optionally include that to interpolate the first pose with the second pose the processor is configured to carry out a Spherical Linear Interpolation, SLERP, of the first pose with the second pose. The features of this paragraph in combination with the twenty-fourth example provide a twenty-fifth example.

The apparatus may optionally include that the processor is configured to sample the pose of the LIDAR sensor with a sampling frequency greater than a scan frequency of the LIDAR sensor. The features of this paragraph in combination with any one of the examples twenty-two to twenty-five provide a twenty-sixth example.

The apparatus may optionally include that the sampling times for sampling the pose of the LIDAR sensor are distributed at regularly spaced time intervals during the first LIDAR scan. The features of this paragraph in combination with any one of the examples twenty-two to twenty-six provide a twenty-seventh example.

The apparatus may optionally include that the processor is further configured to remove a distortion of the first data points to provide an initial alignment between the first data points and the LIDAR map prior to determining the rigid transformation to map the plurality of first data points onto the LIDAR map. The features of this paragraph in combination with any one of the examples twenty to twenty-seven provide a twenty-eighth example.

The apparatus may optionally include that the processor is configured to remove the distortion of the first data points based on motion data from a motion sensor recorded during the first LIDAR scan. The features of this paragraph in combination with the twenty-eighth example provide a twenty-ninth example.

The apparatus may optionally include that to determine the rigid transformation the processor is configured to carry out an iterative closest point algorithm to map each first data point onto the LIDAR map. The features of this paragraph in combination with any one of the examples twenty to twenty-nine provide a thirtieth example.

The apparatus may optionally further include that the processor is further configured to determine an egomotion of the LIDAR sensor based on the determined rigid transformation. The features of this paragraph in combination with any one of the examples twenty to thirty provide a thirty-first example.

The apparatus may optionally further include that the processor is further configured to determine an egomotion of a host of the LIDAR sensor based on the determined rigid transformation. The features of this paragraph in combination with any one of the examples twenty to thirty-one provide a thirty-second example.

The apparatus may optionally further include that the processor is further configured to obtain a plurality of LIDAR scans from the LIDAR sensor (illustratively, not yet part of the LIDAR map), the plurality of LIDAR scans including the first LIDAR scan and one or more further LIDAR scans, wherein to obtain the (first) pose information the processor is configured to determine at least one pose of the LIDAR sensor during the first LIDAR scan based on first data points from the first LIDAR scan and on further data points from another LIDAR scan of the plurality of LIDAR scans. The features of this paragraph in combination with any one of the examples twenty to thirty-two provide a thirty-third example.

The apparatus may optionally further include that the processor is further configured to add the first LIDAR scan to the LIDAR map to provide an updated LIDAR map, after determining the rigid transformation to map the plurality of first data points onto the LIDAR map. The features of this paragraph in combination with any one of the examples one to thirty-three provide a thirty-fourth example.

The apparatus may optionally further include that the processor is further configured to: obtain an additional second LIDAR scan from the LIDAR sensor (illustratively, a further scan not yet part of the map), wherein the second LIDAR scan includes a plurality of second data points; obtain second pose information representative of each of a plurality of second poses of the LIDAR sensor during the second LIDAR scan; and determine a rigid transformation to map each of the plurality of second data points onto the updated LIDAR map based on at least two adjacent poses of the plurality of second poses, wherein to determine the rigid transformation the processor is configured to determine, for each second data point of the plurality of second data points, a pose of the LIDAR sensor at the time of recording the second data point. The features of this paragraph in combination with the thirty-fourth example provide a thirty-fifth example.

The apparatus may optionally further include that to obtain the second pose information the processor is configured to sample the pose of the LIDAR sensor at a plurality of second sampling times during the second LIDAR scan, and that the sampling of the pose of the LIDAR sensor during the second LIDAR scan has a different sampling frequency with respect to the sampling of the pose of the LIDAR sensor during the first LIDAR scan. The features of this paragraph in combination with the thirty-fifth example provide a thirty-sixth example.

The plurality of poses may optionally include up to tens of poses and the plurality of first data points may include hundreds of thousands of data points.

The ratio between the number of data points of the plurality of data points and the number of poses of the plurality of poses may be above thousand.

The first LIDAR scan may include point cloud data and each data point of the plurality of first data points may be a point cloud point resulting from a detection by the LIDAR sensor at an instantaneous acquisition time (IAT) of a part of an environment when the LIDAR sensor was positioned at an instantaneous sensor position associated with the respective point, wherein the point cloud data may include detections of the plurality of objects, wherein the plurality of IATs may span a detection period, wherein the plurality of poses may be poses of the LIDAR sensor at a plurality of at least three baseline time points (BTP), wherein the obtaining of pose information representative of each of a plurality of poses of the LIDAR sensor during the first LIDAR scan may comprise
associating each point cloud point of the plurality of point cloud points with two baseline time points (BTP) out of the plurality of BTPs within the detection period, and determining a weighting factor between the respective point cloud point and each of the BTPs associated to the respective point cloud point
iterating for a plurality of iterations:
   determine an iteration-level sensor position estimation for each BTP of the plurality of BTPs based on an iteration correlation evaluation of a preceding iteration;
   calculate for each point cloud point of the plurality of point cloud points an iteration-level sensor position estimation based on the iteration-level sensor position estimation determined for each of the BTPs associated with the respective point cloud point and the respective weighting factors;
   compute an iteration correlation evaluation based on a spatial correlation between the LIDAR map and the plurality of point cloud points subject to spatial transformation corresponding to the plurality of iteration-level sensor position estimations calculated for the plurality of point cloud points;
      and wherein the at least two adjacent poses of the plurality of poses may be iteration-level sensor position estimations of the two adjacent poses of at least one iteration of the plurality of iterations.

The apparatus may optionally further include the LIDAR sensor communicatively coupled with the processor. The features of this paragraph in combination with any one of the examples twenty to thirty-six provide a thirty-seventh example.

The term “LIDAR scan” is used herein to describe one measurement carried out by a LIDAR sensor in its field of view. A “LIDAR scan” may thus include the emission of light signals (e.g., laser pulses) by the LIDAR sensor, the detection of the back-reflected light signals at the LIDAR sensor, and the measurement of the time it takes for each light signal to return. A “LIDAR scan” may thus include a direct time-of-flight measurement in the field of view of the LIDAR sensor. Measuring the round-trip time of a light signal emitted at certain spatial coordinates allows for the determining of the distance of the object or surface that reflected that light signal back towards the LIDAR sensor. The result of a “LIDAR scan” is thus a plurality of data points, wherein each data point has respective spatial coordinates (e.g., x-, y-, and z-coordinates), and is representative of a respective distance value (e.g., expressed as a distance value, an intensity value, a greyscale value, or with any suitable representation). Illustratively, the collected data points form a so called three-dimensional “point cloud”, where each point is associated to a location in space. A “LIDAR scan” may also be referred to herein as “LIDAR cycle”.

The term “LIDAR map” is used herein to describe an aggregation of a plurality of individual LIDAR scans. Illustratively, a LIDAR scan may refer to the collection of the data points, whereas a “LIDAR map” may be the result of a processing of a plurality of LIDAR scans. A “LIDAR map” may thus include a three-dimensional representation of the scanned scene, obtained by combining together subsequent LIDAR scans. A “LIDAR map” may be created by combining and aligning successive LIDAR scans to obtain the three-dimensional representation of the scene with a denser cloud of data points, as will be described in further detail below.

The term “pose” is used herein to describe the position and the orientation of a LIDAR sensor in three-dimensions at a certain time point. A “pose” may thus include spatial coordinates (e.g., x-, y-, and z-coordinate of the LIDAR sensor), and orientation coordinates (e.g., Euler angles, e.g., pitch, yaw, roll of the LIDAR sensor). A “pose” is thus representative of the position and orientation of the LIDAR sensor with respect to a reference coordinate system. The reference coordinate system may be freely chosen depending on the scenario in which the LIDAR sensor operates. For example, the reference coordinate system may be a global coordinate system (e.g., based on global positioning system, GPS, coordinates), or may be a local coordinate system (e.g., of the host in which the LIDAR sensor is mounted). A “pose” may have any suitable representation, e.g., as a vector, as a matrix, as a quaternion, and the like.

The term “host” is used herein to describe an entity that includes the LIDAR sensor whose data are being processed, e.g., an entity in which the LIDAR sensor is mounted or integrated. In particular, the “host” may be a mobile host, i.e., the host may be capable of moving in space (e.g., along one-dimension, two-dimensions, or three-dimensions). The strategy proposed herein is particularly relevant for mobile hosts, as it makes it possible to compensate for abrupt changes of the pose of the LIDAR sensor that may occur during the movement of the host. In some aspects, the host may be moving during the operation of the LIDAR sensor, and may thus be referred to as “moving host”.

In this regard, the “host” may be any suitable mobile entity. In a preferred configuration, the “host” including the LIDAR sensor may be a vehicle, e.g., a terrestrial vehicle, aerial vehicle, aquatic vehicle. For example, the vehicle may be a car, a bike, a scooter, a motorbike, an aerial drone, a boat, and the like. As another example, the “host” may be a robot, e.g., configured to carry out a certain task and that makes use of the LIDAR sensor to explore the environment. Examples may include a sweeping robot for cleaning a home, a robot for use in a warehouse, a “waiter robot” for offering services in a restaurant, and the like. It is however understood that the approach proposed herein may be applicable to any suitable host that includes a LIDAR sensor.

The term “egomotion” may be used herein to describe the movement of an entity (e.g., a LIDAR sensor, a host of the LIDAR sensor) relative to its environment. The “egomotion” may thus refer to the own movement of the entity, e.g., relative to a reference coordinate system (e.g., a global coordinate system in case of a vehicle). The “egomotion” may thus represent a change in a position of the entity (e.g., a change in its spatial coordinates), and/or a change in an orientation of the entity (e.g., a change in its Euler angles).

By way of illustration, the approach proposed herein may be based on the realization that since the LIDAR sensor data is continuous in time and contains hundreds of thousands of data points, it is possible to constraint poses that model the host movement in time at very high frequency. As an example, with a Velodyne VLS128 sensor that scans about 220 k points in 0.1 seconds there are enough constraints to solve the vehicle movement robustly even at 1000 HZ. The proposed strategy provides an accurate egomotion in more than double the frequency of the LIDAR sensor without the assistance of IMU or similar sensors.

As an exemplary scenario, given an existing reference three-dimensional rigid point cloud of the area the host is moving through (e.g., achieved by simpler LIDAR egomotion algorithms), consider the next 2 seconds of LIDAR measured data, which is about 20 lidar cycles. The poses of the LIDAR sensor (and accordingly, the poses of the host vehicle) during that time are determined such that they will accurately project the LIDAR data sampled during the window onto the rigid three-dimensional reference point cloud.

In classic ICP, the goal is to find a single rigid transformation that will transform one static rigid point cloud to another. The algorithm proposed herein instead may use elastic ICP, thus projecting each point from the window by interpolating the two poses closest in time to its own sample time and using the interpolated pose to project that specific point so that each point is projected with a unique pose that describes the position of the LIDAR sensor (and accordingly, the position of the host vehicle) at the time that point was sampled, in contrast to rigid ICP that project all points with the same pose.

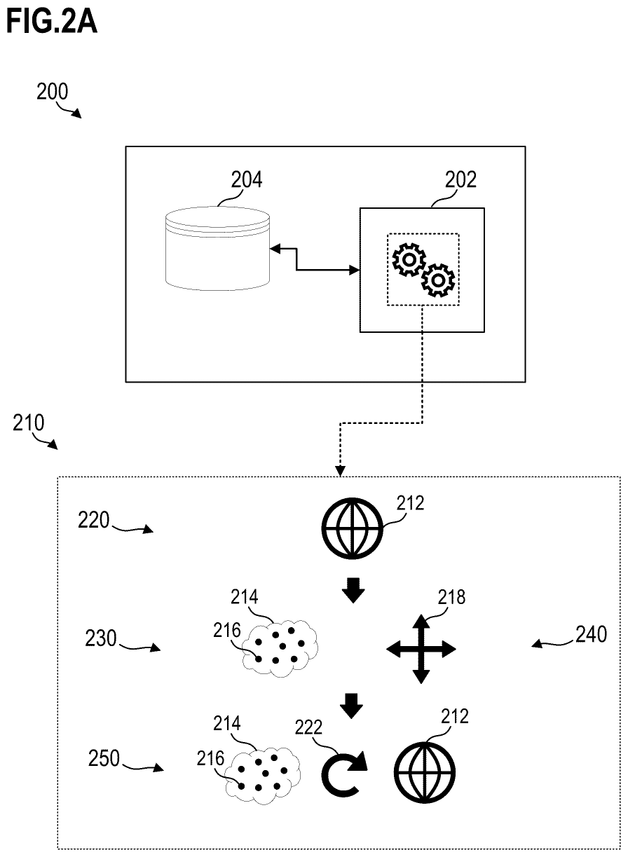

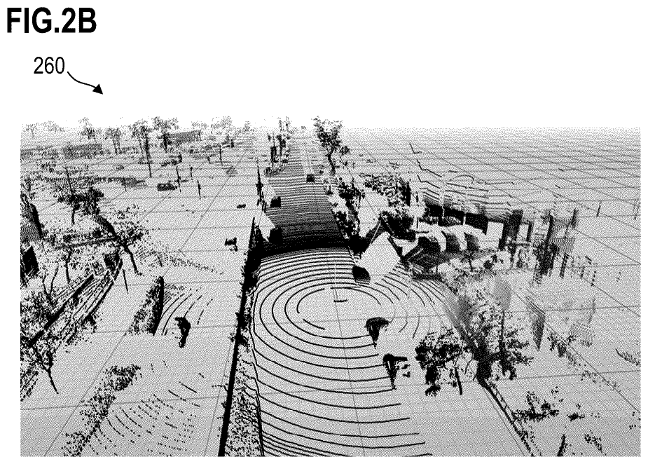

FIG. 2A shows an apparatus 200 for processing data from a LIDAR sensor (also referred to herein as “LIDAR data”), in a schematic representation according to various aspects. In general, the apparatus 200 may be configured to process data according to the adapted approach proposed herein, i.e., by taking into consideration changes to the pose of the LIDAR sensor during a LIDAR scan for the alignment of the LIDAR scan to an existing LIDAR map. It is understood that the representation of the apparatus 200 may be simplified for the purpose of illustration, and the apparatus 200 may include additional components with respect to those shown. Furthermore, reference is made to the processing of data from a LIDAR sensor, but it is understood that the apparatus 200 may be configured to receive LIDAR data from a plurality of LIDAR sensors and process the plurality of LIDAR data.

In general, the apparatus 200 may include a processor 202 and a memory 204 communicatively coupled with one another. The memory 204 may be configured to store instructions (e.g., software instructions, program code) to be executed by the processor 202. The instructions may be configured to cause the processor 202 to perform an adapted method 210 of processing data from a LIDAR sensor, described in further detail below. Aspects described with respect to a configuration of the processor 202 may also apply to the method 210, and vice versa.

A configuration of the processor 202 to carry out a certain function may correspond to a respective step of the method 210, and a step of the method 210 may correspond to a respective configuration of the processor 202 to carry out a certain function that results in the method step. It is understood that the processor 202 may include a single processor (e.g., a single circuit) configured to carry out the method 210, or may include a plurality of processors (e.g., sub-processors, or sub-circuits) each configured to carry out one or more steps of the method 210.

According to various aspects, the processor 202 may be configured to obtain a LIDAR map 212 that includes an aggregation of a plurality of LIDAR scans from a LIDAR sensor (e.g., as first step 220 of the method 210). Illustratively, the LIDAR map 212 may include a plurality of LIDAR scans previously carried out by the LIDAR sensor that are merged together into a unified map of the scene scanned by the LIDAR sensor. The LIDAR map 212 may thus provide a three-dimensional representation of a scene (illustratively, of the field of view of the LIDAR sensor) obtained by aggregating the data points of the individual (previous) LIDAR scans.

In some aspects, the LIDAR map 212 may consist exclusively of LIDAR scans from the LIDAR sensor for which the subsequent processing is carried out. In other aspects, the LIDAR map 212 may include LIDAR scans from the LIDAR sensor, and may further include other LIDAR scans from other LIDAR sensors. Illustratively, in this second scenario, the LIDAR map 212 may be an aggregation of LIDAR scans from multiple LIDAR sensors, which may provide a more comprehensive understanding of the scene (e.g., from different standpoints). In the following, reference is made in general to a LIDAR map 212 obtained based on the LIDAR scans from the LIDAR sensor whose data are further processed, but it is understood that the aspects discussed herein apply in a corresponding manner to a LIDAR map obtained based on LIDAR scans from multiple LIDAR sensors.

The generation of a LIDAR map from LIDAR scans is generally known in the art, and any suitable technique or algorithm may be used. In brief, the individual point clouds of the LIDAR scans are transformed into a common coordinate system, which may be referred to as reference coordinate frame of the LIDAR map. For example, the common coordinate system may be the global coordinate system. Illustratively, the data points of the LIDAR scans may be translated and/or rotated so as to align to the common coordinate system. The aligned scans are then merged to provide the unified LIDAR map, wherein overlapping data points (illustratively, data points from different LIDAR scans having the same coordinates in the common coordinate system) may be blended or averaged.

In this regard, the processor 202 may generate the LIDAR map 212, or may receive the LIDAR map 212. Illustratively, in some aspects, the processor 202 may be configured to receive the LIDAR scans from the LIDAR sensor and aggregate the LIDAR scans to generate the LIDAR map 212 (using any suitable technique known in the art). In other aspects, the LIDAR map 212 may be generated by an entity other than the processor 202, and the processor 202 may receive the already prepared LIDAR map 212 (e.g., the processor 202 may retrieve the LIDAR map 212 from memory).

The initialization of the map may thus be carried out in any suitable manner (e.g., by the processor 202 or by another entity), for example using the standard LIDAR egomotion approach outlined in FIG. 1B or FIG. 1C. Starting from the existing LIDAR map 212, the processor 202 may then apply the adapted strategy of the present disclosure.

The LIDAR map 212 may be an aggregation of any suitable number of LIDAR scans from the LIDAR sensor. As a numerical example, the processor 202 may start applying the adapted approach for LIDAR egomotion after the LIDAR map 212 contains a number of LIDAR scans above a predefined threshold, e.g., at least 10 LIDAR scans, or at least 15 LIDAR scans, or at least 20 LIDAR scans. Illustratively, the predefined threshold may ensure that the LIDAR map 212 provides a sufficiently detailed understanding of the scene. Up until the threshold is reached, the LIDAR map 212 may be generated using a standard approach.

The processor 202 may be further configured to obtain a (first) LIDAR scan 214 from the LIDAR sensor (e.g., as second step 230 of the method 210). The processor 202 may receive the output (in other words, the result) of the first LIDAR scan 214, e.g., directly from the LIDAR sensor or from an intermediate processing entity disposed between the LIDAR sensor and the processor 202. The first LIDAR scan 214 is a new scan carried out by the LIDAR sensor (whose scans have been used to generate the LIDAR map 212), which has not yet been merged into the LIDAR map 212. In other words, the first LIDAR scan 214 is an additional LIDAR scan, which is not part of the LIDAR map 212. The first LIDAR scan 214 may thus be a scan performed by the LIDAR sensor at a later time point with respect to the LIDAR scans already merged into the map, e.g., may be the immediately next LIDAR scan.

In general, the first LIDAR scan 214 may include a plurality of (first) data points 216, each having spatial coordinates and representative of a distance. A “data point of a LIDAR scan” may also be referred to herein as “scan point”. A LIDAR scan processed with the approach proposed herein (e.g., the first LIDAR scan 214) may include any suitable number of data points. As a numerical example, a LIDAR scan processed with the approach proposed herein (e.g., the first LIDAR scan 214) may include a number of data points in the range from 50000 to 500000, e.g., in the range from 100000 to 300000.

In general, a LIDAR scan (e.g., the first LIDAR scan 214) covers the field of view of the LIDAR sensor. The field of view may be expressed as the angular range that the LIDAR sensor is capable of interrogating via light emission and detection. For example, the field of view of the LIDAR sensor (illustratively, the field of view covered by a LIDAR scan) may be 120° (120 degrees) or 360 ° (360 degrees), depending on the configuration of the sensor. A LIDAR sensor having a field of view of 120° may be referred to as “front-facing”. For illustration purposes, an exemplary 360° LIDAR scan 260 of a road is shown in FIG. 2B.

According to various aspects, the LIDAR sensor may be configured to continuously scan the field of view. The LIDAR sensor may thus be configured to carry out a “scanning LIDAR” measurement. Illustratively, the LIDAR sensor may carry out a LIDAR scan starting from an initial coordinate of the field of view (illustratively, an origin), scan the individual points continuously until a final coordinate of the field of view, and then immediately proceed with the subsequent LIDAR scan. The LIDAR sensor may thus be configured to continuously measure the scene, and deliver the sequence of data points to the processor 202. The continuous scanning may be exploited to enhance the accuracy of determining the pose of LIDAR sensor, as will be discussed in further detail below.

Stated differently, the processor 202 may receive the first LIDAR scan 214 as a sequence of first data points 216, rather than as a single block of data points. During the first LIDAR scan 214, the processor 202 may thus receive the first data points 216 in sequence over the time it takes for the LIDAR sensor to complete the first LIDAR scan 214. The approach proposed herein may exploit the continuous scanning of the world throughout the scan time by evaluating the variations in the pose of the LIDAR sensor during the scan, as discussed below. On the contrary, conventional approaches treat the LIDAR scans “discretely” (i.e., considering all data points at once), without taking advantage of the continuous nature of the measurements.

In this context, the LIDAR sensor may have any suitable scan frequency (also referred to as “scanning frequency”). The scan frequency may represent the inverse of the time it takes for the LIDAR sensor to complete a scan of its field of view (from the origin to the final coordinate). From a different perspective, the scan frequency may represent the number of LIDAR scans per second that the LIDAR sensor is carrying out. As a numerical example, the LIDAR sensor may have a scan frequency in the range from 5 Hz to 100 Hz, e.g., a scan frequency of 10 Hz. A LIDAR scan may thus have a time duration corresponding to the inverse of the scan frequency, e.g., 0.1 seconds in case of a 10 Hz scan frequency.

As mentioned, the proposed approach may exploit the continuous nature of the scanning, so that rather than carrying out processing at the same frequency as the scanning of the LIDAR sensor, the processor 202 considers the data points 216 in the point cloud as independent measurements. The processing occurs thus at a higher frequency compared to conventional solutions, thus enhancing the accuracy of the egomotion calculation.

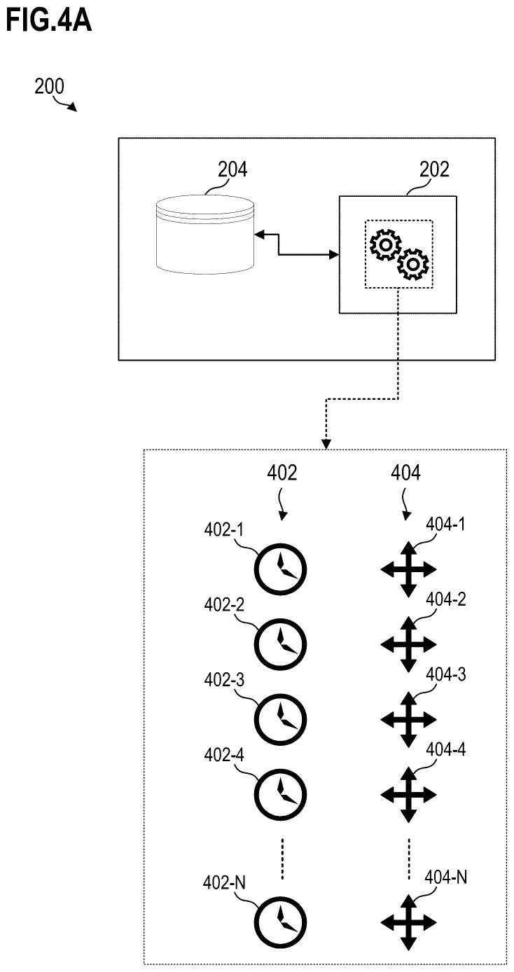

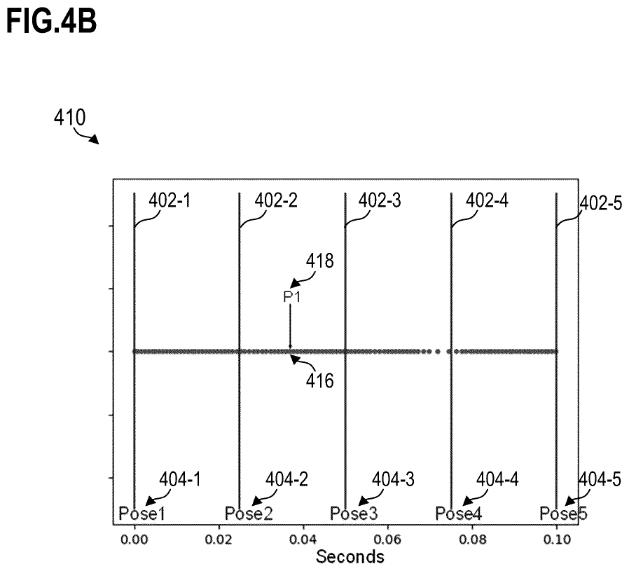

The processor 202 may be further configured to obtain (first) pose information 218 (e.g., as third step 240 of the method 210). The (first) pose information 218 is representative of a plurality of poses of the LIDAR sensor during the first LIDAR scan 214. Illustratively, the (first) pose information 218 may represent spatial and angular coordinates of the LIDAR sensor at a plurality of time points during the first LIDAR scan 214. In this regard, the (first) pose information 218 may be representative of any suitable number of poses (see also FIG. 4A), e.g., two, three, four, five, ten, or more than ten. For example, the (first) pose information 218 may be representative of at least three poses of the LIDAR sensor during the first LIDAR scan 214, e.g., an initial pose at the beginning of the scan, an intermediate pose at half of the duration of the scan, and a final pose at the end of the scan. Increasing the number of poses may increase the accuracy of the process. In this regard, the processor 202 may be configured to determine (e.g., calculate) the pose information 218 or may receive the pose information 218 from another processing entity.

The pose of the LIDAR sensor may be directly related to the pose of the host (e.g., of the vehicle) in which the LIDAR sensor is mounted. Thus, aspects discussed herein in relation to the pose of the LIDAR sensor may apply in a corresponding manner to the pose of the host, and vice versa.

The processor 202 may be further configured to determine a rigid transformation 222 to map the plurality of first data points 216 onto the LIDAR map 212 (e.g., as fourth step 250 of the method 210). Illustratively, the processor 202 may determine (e.g., calculate) how to transform the coordinates of the data points 216 of the LIDAR scan 214 into the coordinates of the data points of the LIDAR map 212 (also referred to herein as “map points”). Stated differently, the processor 202 may be configured to determine the transformation 222 suitable to align the data points 216 of the LIDAR scan 214 to the coordinate system of the LIDAR map 212 (illustratively, the reference coordinate frame). A “rigid transformation” may ensure that distances and angles represented by the data points of the LIDAR scan are preserved, thus maintaining the original shapes, spatial relationships, etc. The rigid transformation 222 may thus include, for each data point 216, one or more of a translation, reflection, rotation, or any suitable geometric operation to map that (first) data point 216 onto the LIDAR map 212.

According to the adapted approach proposed herein, the processor 202 is configured to determine the rigid transformation 222 by determining, for each first data point 216, a respective pose of the LIDAR sensor at the time of recording that first data point 216. Illustratively, the processor 202 may be configured to estimate the pose of the LIDAR sensor at the time point at which a first data point 216 is recorded, and to adjust the coordinates of that first data point 216 according to the respective pose for then determining the rigid transformation 222 that would map that (pose-adjusted) first data point 216 onto the LIDAR map 212. The processor 202 may thus determine the rigid transformation 222 for a first data point 216 based on at least two adjacent poses of the plurality of poses, illustratively using at least two temporally consecutive poses among the plurality of poses, as will be discussed in further detail below.

Stated in a different fashion, the processor 202 may determine (e.g., calculate, estimate) for each data point 216 the actual pose of the LIDAR sensor for that data point 216, rather than relying on a “monolithic understanding” with just a single pose for the entire LIDAR scan 214. The processor 202 may further determine one or more corrections for the coordinates of each data point 214 based on the respective pose of the LIDAR sensor, and may then find the rigid transformation 222 for the “pose-corrected” data points. The processor 202 may use the pose of the LIDAR sensor to adjust the spatial relationship between the LIDAR sensor and the scene, to then transform the data points 216 into the coordinate system of the map 212. By correcting for the poses, the points 214 will project more closely to the map 212, and thus the result is very accurate high frequency egomotion data and very accurate aggregation of LIDAR data 214, 216 in the reference coordinate frame of the LIDAR map 212 (e.g., a global reference frame).

The rigid transformation 222 may include a projection of the first data points 216 onto the LIDAR map 212. Illustratively, the processor 202 may be configured to project each data point 216 onto the coordinate system of the LIDAR map 212, and the rigid transformation 222 includes the geometric operations that result in the projection. According to the adapted approach proposed herein, the processor 202 may project each data point 216 onto the map 212 using the respective pose of the LIDAR sensor for that data point 216. Illustratively, the processor 202 may project each data point 216 using corrected coordinates for that data point 216 based on the pose of the LIDAR sensor.

In this regard, the rigid transformation 222 may be determined according to any suitable algorithm known in the art for projecting the points of a LIDAR scan onto a LIDAR map. In a preferred configuration, the processor 202 may carry out an iterative closest point algorithm (ICP) to map each (pose-corrected) first data point 216 onto the LIDAR map 212. As generally known, the ICP algorithm iteratively finds the closest points between the new scan 214 and the existing map 212, and minimizes the difference between such points (by adjusting rotation and/or translation parameters of the data points 216). The ICP algorithm provides a robust and time-efficient solution for the mapping of a scan onto a map.

It is however understood that in principle the processor 202 may determine the rigid transformation 222 for mapping the data points 216 onto the map 212 according to any (other) suitable approach or algorithm. Other examples may include Normal Distribution Transform (NDT), Super 4-Point Congruent Sets (Super 4PCS), or Random Sample Consensus (RANSAC)-based algorithms.

After having determined the transformation 222, the processor 202 may determine the egomotion of the LIDAR sensor and/or the egomotion of the (mobile) host of the LIDAR sensor based on the rigid transformation 222. As mentioned, the rigid transformation 222 may represent how to transform the coordinates of the data points 216 of the LIDAR scan 214 to match the coordinates of the reference frame of the map 212, and thus may be representative of the movement (in other words, the displacement) of the LIDAR sensor and/or host during the LIDAR scan 214. Stated differently, the processor 202 may determine (e.g., calculate, estimate) the displacement of the LIDAR sensor and/or host during the LIDAR scan 214 based on the transformation to be provided for mapping the data points 216 of the LIDAR scan 214 onto the LIDAR map 212.

The determined egomotion of the host may assist further functionalities. In this regard, the processor 202 may be configured to cause a transmission of the result of the determination of the egomotion of the host to a further processing entity. For example, the processor 202 may transmit the result of the egomotion of the host to a central control unit of the host. As another example, the processor 202 may be configured to determine an instruction (or to cause determining an instruction) for controlling an operation of the host based on the determined egomotion of the host. The instruction may include, for example, a driving instruction to control a movement of the host (e.g., of a vehicle). As another example, the processor 202 may be configured to determine an instruction to adjust one or more measurement results (e.g., by the LIDAR sensor, or by other sensors of the host) based on the egomotion, e.g., to remove distortions in the results caused by the movement of the host.

In some aspects, the processor 202 may be configured to remove a distortion from the first LIDAR scan 214 using the determined egomotion of the LIDAR sensor (and/or of the host) during the LIDAR scan 214. Illustratively, the processor 202 may be configured to adjust one or more spatial coordinates of the first data points 216 based on the egomotion of the LIDAR sensor (and/or of the host) during the LIDAR scan 214. The processor 202 may remove the distortion based on the egomotion prior to adding the LIDAR scan 214 to the map 212, thus reducing the risk of misalignments.

According to various aspects, the processor 202 may be further configured to add the first LIDAR scan 214 to the LIDAR map 212, thereby providing an updated LIDAR map for use in the processing of further LIDAR scans. Using the rigid transformation 222 the processor 202 may add the data points 216 of the LIDAR scan 214 to the map 212, e.g., by adding new points to the map 212 in case the map 212 did not have any data points at the coordinates of the newly added data points 216, or by merging (e.g., averaging) with the existing data points of the map 212 in case the map 212 already has data points at the coordinates of the newly added data points 216.

Adding the LIDAR scan 214 to the LIDAR map 212 may be based on any suitable technique known in the art and may include any suitable processing of the data points 216, such as smoothing, density adjustment, duplicate removal, and the like. Optionally, after having added the scan 216 to the map 212, the processor 202 may carry out a post-processing of the updated LIDAR, e.g., by checking for consistency, removing artifacts, filtering, and the like.

Although FIG. 2A shows the scenario related to processing one LIDAR scan 214, it is understood that the processing may be carried out continuously for a plurality of LIDAR scans, e.g., in sequence. For each LIDAR scan, the processor 202 may obtain respective pose information representative of the pose of the LIDAR sensor at the time of recording the data points of that LIDAR scan, and may determine the rigid transformation to map the data points of that LIDAR scan onto the LIDAR map (updated using the previously processed scans) using the respective pose of the LIDAR sensor associated with each data point.

For example, the processor 202 may further obtain an additional second LIDAR scan from the LIDAR sensor, having a plurality of second data points. The second LIDAR scan is not yet part of the map, and may be temporally subsequent to the first LIDAR scan 214 (e.g., may be immediately adjacent in time to the first LIDAR scan 214).

The processor 202 may obtain further (second) pose information representative of each of a plurality of second poses of the LIDAR sensor during the second LIDAR scan, and determine a rigid transformation to map the plurality of second data points onto the updated LIDAR map (after having added the first LIDAR scan), using, for each second data point, the respective pose of the LIDAR sensor at the time of recording that second data point. The same may apply to a third LIDAR scan having third data points, using third pose information to map the third data points onto the LIDAR map that was updated with the second LIDAR scan, etc.

The processor 202 may further determine the egomotion of the LIDAR sensor and/or of the host based on a plurality of rigid transformations, illustratively based on rigid transformations each obtained from a respective LIDAR scan of the plurality of LIDAR scans that are added to the map according to the approach of the present disclosure.

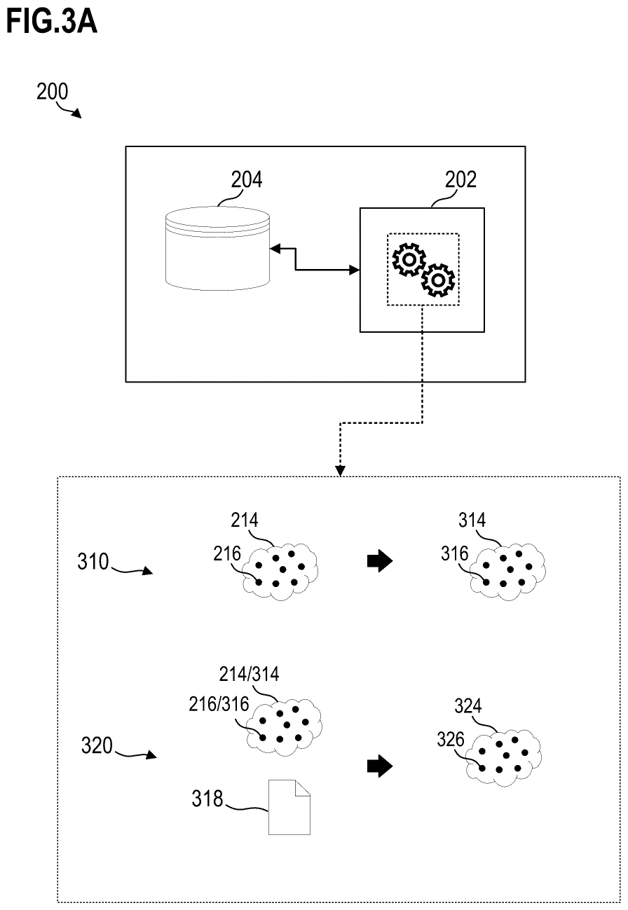

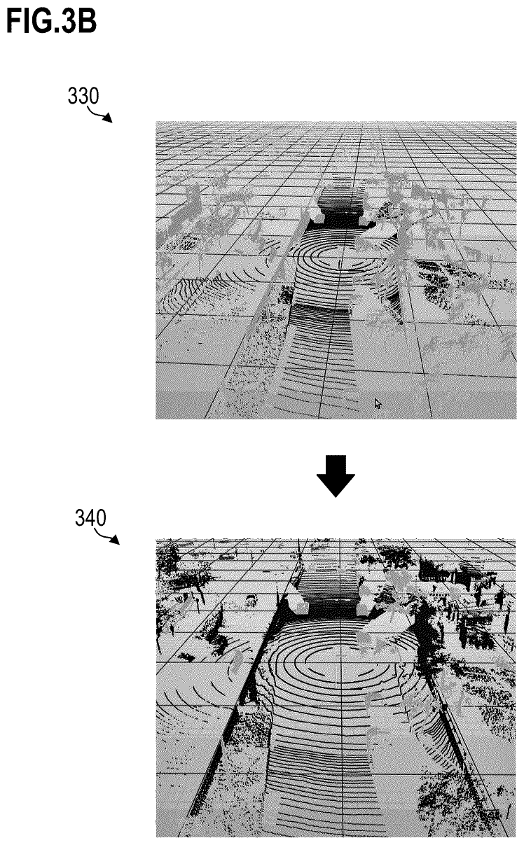

According to various aspects, as shown in FIG. 3A and FIG. 3B, a LIDAR scan may be pre-processed and/or undistorted before determining the (pose-corrected) rigid transformation to map the scan onto the existing LIDAR map. Although described together in the context of FIG. 3A, it is understood that the pre-processing and the undistortion may be independent from one another, so that the processor 202 (as part of the method 210) may be configured to carry out none of the pre-processing and the undistortion, just one of the pre-processing or the undistortion, or both of the pre-processing and the undistortion, e.g., based on a tradeoff between accuracy and complexity. The processor 202 may then determine the rigid transformation to map the pre-processed LIDAR scan 314 or the undistorted LIDAR scan 324 onto the LIDAR map 212 (e.g., after having corrected for the egomotion, as discussed in relation to FIG. 2A).

In the following, reference is made to pre-processing 310 and undistortion 320 of the first LIDAR scan 214, but it is understood that the processor 202 may carry out pre-processing 310 and/or undistortion 320 for each LIDAR scan to be added to the LIDAR map (e.g., the second LIDAR scan, the third LIDAR scan, etc.).

The processor 202 may be configured to carry out a pre-processing 310 of a LIDAR scan (e.g., of the first LIDAR scan 214, and any subsequent LIDAR scan) to deliver, as result, a pre-processed LIDAR scan, e.g., a first pre-processed LIDAR scan 314. The pre-processing 310 may include any suitable type of operation to improve the quality of the data points (as pre-processed data points 316).

For example, the pre-processing 310 may include noise filtering, such that the pre-processed LIDAR scan 314 may have reduced noise compared to the initial non-processed LIDAR scan 214. The noise filtering may include any suitable noise reduction technique, e.g., to remove data points 214 that are statistical outliers in the LIDAR scan 214. As another example, the pre-processing 310 may include down-sampling, such that the pre-processed LIDAR scan 314 may have less data points 316 compared to the initial non-processed LIDAR scan 214. Down-sampling may reduce the computational effort of the further processing.

In a preferred configuration, as part of the pre-processing 310 the processor 202 may be configured to remove from the LIDAR scan 214 the data points 216 that belong to moving objects in the scene. Illustratively, the processor 202 may be configured to identify which first data points 216 may be originating from moving objects, and may remove such identified first data points 216 that are then not part of the pre-processed data points 316. Removing moving objects from the analysis reduces the risk of distortions when evaluating the egomotion of the LIDAR sensor and/or of the host.

As illustrated in FIG. 3B for an exemplary non-processed LIDAR scan 330 and a corresponding pre-processed LIDAR scan 340, the processor 202 may be configured to find the data points 216 that belong to the ground (e.g., using a heuristic algorithm), and to remove the clusters of data points 216 that are above the ground. Illustratively, considering the scenario in which the host is a ground vehicle (e.g., a car), the clusters above the ground (e.g., above the road plane) are most likely other traffic participants, which may be clustered together and removed from the evaluation of the egomotion. Identifying which data points 216 belong, or do not belong, to moving objects may be based on reference parameters, such as a known height of the LIDAR sensor, a known orientation, and the like.

According to various aspects, additionally or alternatively to the pre-processing 310, the processor 202 may carry out an undistortion 320 of the LIDAR scan 214 (if no pre-processing 310 is carried out) or of the pre-processed LIDAR scan 314 (if pre-processing 310 is carried out). Illustratively, the processor 202 may remove a distortion from the LIDAR scan 214, 314 caused by the displacement of the host during the LIDAR scan, prior to proceeding further with determining the rigid transformation 222.

The processor 202 may thus remove a distortion of the first data points 216, 316 to provide an initial alignment between the first data points 216, 316 and the LIDAR map 212, prior to determining the rigid transformation 222. Removing the distortion may enhance the precision with which the rigid transformation 222 is then determined. For example, considering the use of ICP algorithm, starting from an undistorted point cloud facilitates the convergence of the algorithm. As a result, an undistorted LIDAR scan 324 including a plurality of undistorted data points 326 is obtained.

In this regard, the processor 202 may use any suitable technique for removing the distortion from the first data points 216, 316. In a preferred configuration, the processor 202 may remove the distortion based on motion data from a motion sensor recorded during the first LIDAR scan 214. The motion data may be representative of a displacement of the LIDAR sensor during the LIDAR scan 214, so that the processor 202 may carry out an initial correction of the coordinates of the data points 216 based on the displacement of the LIDAR sensor.

For example, the motion data may include inertial measurement data. The processor 202 may receive the inertial measurement data from an inertial measurement sensor (e.g., a gyroscope, an accelerometer, or the like) configured to detect the movement of the LIDAR sensor. For example, the inertial measurement sensor may be part of the LIDAR sensor, or may be coupled with the LIDAR sensor. As another example, additionally or alternatively the motion data may include odometer data (e.g., considering the scenario in which the LIDAR sensor is mounted on a wheeled vehicle). The processor 202 may receive the odometer data from an odometer of the vehicle that is configured to measure the distance travelled by the vehicle, and may thus represent in an indirect manner the displacement of the LIDAR sensor during the LIDAR scan 214.

According to various aspects, as shown in FIG. 4A and FIG. 4B, the processor 202 may be further configured to sample the pose of the LIDAR sensor at a plurality of sampling times during each LIDAR scan. Illustratively, to obtain the pose information (e.g., the first pose information 218 for the first LIDAR scan 214, and further pose information for further LIDAR scans), the processor 202 may determine the pose of the LIDAR sensor at a plurality of time points during a scan. A “sampling time” may be referred to herein as “sampling time point”. During each LIDAR scan to be added to the LIDAR map, the processor 202 may determine a plurality of poses.

In FIG. 4A the sampling is schematically illustrated with reference to a plurality of sampling times 402 (e.g., first to N-th sampling time 402-1, . . . , 402-N) and a plurality of sampled poses 404 (e.g., first to N-th sampled poses 404-1, 404-N), each sampled at a respective sampling time. In this regard, the number of sampled poses per LIDAR scan may be freely selected, according to a desired tradeoff between accuracy and computational effort. Only as a numerical example, the processor 202 may be configured to sample at least three poses (at respective sampling time points), e.g., at least five poses, e.g., at least ten poses, e.g., at least twenty poses.

Various techniques exist for sampling the pose of a LIDAR sensor. As an example, the processor 202 may receive data from other sensors, such as an inertial measurement sensor, a GPS sensor, an odometer, a camera, etc., and may estimate the pose of the LIDAR sensor based on the data from the other sensors. Illustratively, the data from the one or more other sensors may be representative of the pose of the LIDAR sensor, or of a displacement of the LIDAR sensor with respect to a reference position, and the processor 202 may estimate the pose based on the data from the one or more other sensors.

In a preferred configuration, the processor 202 may be configured to determine the pose of the LIDAR sensor based on the data points of the LIDAR scan that is being processed (e.g., the first data points 216 of the first LIDAR scan 214, the second data points of the second LIDAR scan, etc.). Using the data points of the LIDAR scan allows for the determining of the pose without relying on additional sensors, and the generally high number of data points available ensures an accurate evaluation of the pose of the sensor.

The processor 202 may thus be configured to determine the pose of the LIDAR sensor based on data points recorded before and/or after the sampling time of the pose. Illustratively, the pose of the LIDAR sensor may be determined based on data points recorded in the time interval between the sampling time of the pose and the sampling time of the previous pose and/or in the time interval between the sampling time of the pose and the sampling time of the next pose.

With reference for example to the graph 410 in FIG. 4B, determining the second pose 404-2 at the second sampling time 402-2 may be carried out using the subset of data points recorded between the first sampling time 402-1 of the first pose 404-1 and the second sampling time 402-2 in combination with the subset of data points recorded between the second sampling time 402-2 and the third sampling time 402-3 of the third pose 404-3. In case of poses at the edges of the scan (e.g., the first pose 404-1 and the fifth pose 404-5 in the example of FIG. 4B), the pose may be determine using the subset of data points recorded after the sampling time or before the sampling time, e.g., the data points recorded between the first sampling time 402-1 and the second sampling time 402-2 for the first pose 404-1, or the data points recorded between the fourth sampling time 402-4 and the fifth sampling time 402-5 for the fifth pose 404-5.

For example, the sampling times may be distributed at regularly spaced time intervals during the LIDAR scan, thus providing a homogeneous assessment of the pose over the duration of the LIDAR scan. However, it is understood that in principle the sampling times may be irregularly spaced over the duration of the LIDAR scan.

Determining the pose 404 of the LIDAR sensor based on the data points may make use of any suitable technique or algorithm known in the art. In general, the processor 202 may determine the pose 404 at a sampling time 402 based on a difference between the respective spatial coordinates of the data points and reference coordinates. Illustratively, the processor 202 may determine the pose 404 at a sampling time 402 based on a deviation of the spatial coordinates of the data points recorded before/after the sampling time 402 with respect to a reference coordinate system.

In other words, the poses 404 at the sampling times 402 (e.g. baseline time points (BTPs) may rely on the 3D information (i.e. the spatial coordinates) of the data points (e.g. point cloud data points acquired at other detection times than the sampling times 402, such as the data point 416 recorded in the time interval between the second sampling time 402-2 and the third sampling time 402-3) rather than information from additional sensors such as an IMU. Thus, no additional sensors are necessary. Moreover, determining poses 404 using the data points may allow determining the poses 404 at a higher rate as well as higher accuracy than using an IMU. Thus, use cases may be supported which require pose estimations at a high rate.

According to one embodiment, the method of FIG. 7 may be used for determining the poses 404 at the sampling times 402. In that case, the sampling times 402 for example correspond to the baseline time points (BTPs) of the method of FIG. 7.

For this purpose, the processor 202 may consider any suitable number of data points for determining a pose 404. In principle, considering that a pose 404 may have six degrees of freedom (illustratively, the three spatial coordinates and the three orientation coordinates), three data points may suffice to mathematically obtain the pose 404. However, to obtain a more robust solution the processor 202 may use a higher number of data points for determining each pose 404. As a numerical example, the processor 202 may determine a pose 404 at a sampling time 402 using at least 100 data points, e.g., at least 500 data points, e.g., at least 1000 data points. For example, the data points may be symmetrically distributed before and after the sampling time 402 for that pose 404. The number of data points to be used may be selected according to a desired tradeoff between robustness and frequency of the pose determination.

In this regard, the sampling of the pose of the LIDAR sensor may have any suitable sampling frequency. In this context, the sampling frequency may describe the number of samplings per second, which accordingly may describe the number of samplings per LIDAR scan. Illustratively, the inverse of the sampling frequency may represent the time difference between consecutive sampling times 402. In the exemplary scenario of FIG. 4B, a sampling frequency of 30 Hz (with a scan frequency of 10 Hz) is illustrated.

In general, the sampling frequency may be greater than the scan frequency of the LIDAR sensor, to ensure sampling of multiple poses during each LIDAR scan. For example, the sampling frequency may be at least twice the scan frequency, e.g., at least three times the scan frequency, e.g., at least five times the scan frequency, e.g., at least ten times the scan frequency. As a numerical example, the sampling frequency may be in the range from 20 Hz to 100 Hz, e.g., in the range from 30 Hz to 50 Hz. Simulations showed that a sampling frequency being triple the scan frequency may be a particularly suitable solution to balance accuracy and computational effort (e.g., 30 Hz sampling with 10 Hz scanning).

Sampling the poses at a higher frequency compared to the LIDAR scan allows for the following of the egomotion of the LIDAR sensor and of the host at a higher frequency compared to conventional LIDAR approaches, which are limited to the LIDAR frequency. The proposed approach enhances thus the accuracy of the egomotion determination, in particular in case of high frequency events during the movement of the host.

As discussed in relation to FIG. 2A, the approach proposed herein may be carried out on a plurality of LIDAR scans. In general, the sampling frequency may remain constant among the different LIDAR scans, thus ensuring a reproducible processing. In some aspects, however, the sampling frequency may be dynamically adapted, to better tailor the sampling of the pose of the LIDAR sensor to the scenario at hand.

Considering a first LIDAR scan (e.g., the first LIDAR scan 214) and a second LIDAR scan, the processor 202 may sample the pose of the LIDAR sensor at a plurality of first sampling times during the first LIDAR scan with a first sampling frequency, and may sample the pose of the LIDAR sensor at a plurality of second sampling times during the second LIDAR scan with a second sampling frequency. In some aspects, the first sampling frequency may be different from the second sampling frequency. The same may apply to a third LIDAR scan with a third sampling frequency different from the first sampling frequency and second sampling frequency, etc.

For example, the second sampling frequency may be greater than the first sampling frequency. This may allow the processor 202 to obtain more granular information, e.g., in case particularly turbulent conditions are expected. As another example, the second sampling frequency may be less than the first sampling frequency. This may allow the processor 202 to save computational resources, e.g., in case particularly stable conditions are expected. For example, the adjustment of the sampling frequency may be “event-based”, e.g., the processor 202 may detect the occurrence of an event and change the sampling frequency in response to detection of the event. As examples, the event may be a violent driving maneuver, a series of sharp curves along the driving trajectory, a series of speed bumps or pot holes along the driving trajectory, and the like.

In some aspects, the processing of multiple LIDAR scans may be exploited to reduce the influence of edge effects in the pose determination. As discussed above, the poses at the edges of the LIDAR scan may be constrained only by the data points after the sampling time or before the sampling time, thus introducing the risk of having distortions in the assessment. In some aspects, the processor 202 may be configured to determine at least one pose of the LIDAR sensor during a LIDAR scan (e.g., the first LIDAR scan 214) using data points from the LIDAR scan and further data points from another LIDAR scan (e.g., the LIDAR scan immediately adjacent in time, e.g., a second LIDAR scan).

Illustratively, the processor 202 may determine at least one pose for a LIDAR scan (in particular, a pose at one edge of the LIDAR scan) using the data points of the LIDAR scan recorded after or before the sampling time, and further using the data points of the adjacent LIDAR scan that were recorded before or after the sampling time.

Considering for example the sampling time 402-5 at the end of a LIDAR scan, the processor 202 may determine the corresponding pose 404-5 using the data points of the LIDAR scan recorded between the sampling time 404-5 and the previous sampling time 404-4 within the LIDAR scan, and further using the data points of the subsequent LIDAR scan recorded between the sampling time 404-5 and the next sampling time within the next LIDAR scan.

As another example, considering the sampling time 402-1 at the beginning of a LIDAR scan, the processor 202 may determine the corresponding pose 404-1 using the data points of the LIDAR scan recorded between the sampling time 404-1 and the next sampling time 404-2 within the LIDAR scan, and further using the data points of the preceding LIDAR scan recorded between the sampling time 404-1 and the previous sampling time within the previous LIDAR scan.

It is understood that the “moving window” for determining a pose may also encompass more than one time interval in the previous scan or subsequent scan, depending on a desired robustness of the solution. Thus, in some aspects the processor 202 may optimize multiple LIDAR cycles together (e.g., 10 or 20 LIDAR cycles, as an example), instead of each cycle separately, to reduce the effects of edge behavior.

In this scenario, the processor 202 may refrain from mapping each LIDAR scan immediately at the end of the scan, and may rather wait for the reception of multiple LIDAR scans (e.g., any predefined number, such as 10, 20, or more than 20), obtain the poses for the multiple LIDAR scans, and then determine the respective rigid transformations based on the obtained poses. By way of illustration, the approach proposed herein may be understood as an improvement of the elastic method (of FIG. 1B or 1C), in which instead of solving a single cycle of LIDAR with 2 poses, it solves multiple cycles (e.g., 20 or more) with many poses depending on the required frequency (e.g., 30 Hz). Then, the entire window may be mapped onto the existing map (e.g., using ICP), as discussed in FIG. 2A.

Having obtained (e.g., sampled) the poses 404 associated with a LIDAR scan, the processor 202 may determine the respective pose associated with a data point of the LIDAR scan in any suitable manner. In particular, the processor 202 may determine the respective pose associated with a data point by interpolating first pose sampled at a first sampling time before the time of recording of that data point with a second pose sampled at a second sampling time after the time of recording of that data point. With reference to FIG. 4B, to estimate the pose 418 for data point 416 recorded in the time interval between the second sampling time 402-2 and the third sampling time 402-3, the processor may interpolate the second pose 404-2 and the third pose 404-3.

This interpolation may for example be an interpolation according to the weighting factors mentioned in step 703 of the method illustrated in FIG. 7. So, the interpolation may for example correspond to the calculation of (iteration-level) sensor position estimation for each point cloud point of the plurality of point cloud points in step 706 of the method of FIG. 7 or, when the iterative process has been completed, the sensor position estimation for each of the plurality of point cloud points of step 708. For example, the sampling times 402 may correspond to the baseline time points (BTPs) of the method of FIG. 7 and the instantaneous acquisition time (IAT) of the method of FIG. 7 may correspond to the sampling time of a data point 416 (which may correspond to one of the point cloud points of the plurality of point cloud points of FIG. 7).

It is understood that in principle the processor 202 may determine the respective pose with a data point by interpolating more than two poses. For example, the processor 202 may determine the respective pose of a data point by interpolating a plurality of poses sampled at respective sampling times before the time of recording of that data point with a plurality of poses sampled at respective sampling times after the time of recording of that data point. As another example, the processor 202 may determine the respective pose of a data point by interpolating a plurality of poses sampled at respective sampling times before the time of recording of that data point with a single pose sampled at a sampling time after the time of recording of that data point. As a further example, the processor 202 may determine the respective pose of a data point by interpolating a single pose sampled at a sampling time before the time of recording of that data point with a plurality of poses sampled at respective sampling times after the time of recording of that data point.

The processor 202 may apply suitable interpolation technique. In a preferred configuration, the processor 202 may carry out a Spherical Linear Interpolation, SLERP, of the first pose with the second pose to obtain the pose 404 at the time point at which a data point was recorded. SLERP ensures a smooth and predictable interpolation, thus enhancing the reliability and robustness of the processing. It is however understood that the processor 202 may make use of any other suitable interpolation algorithm.

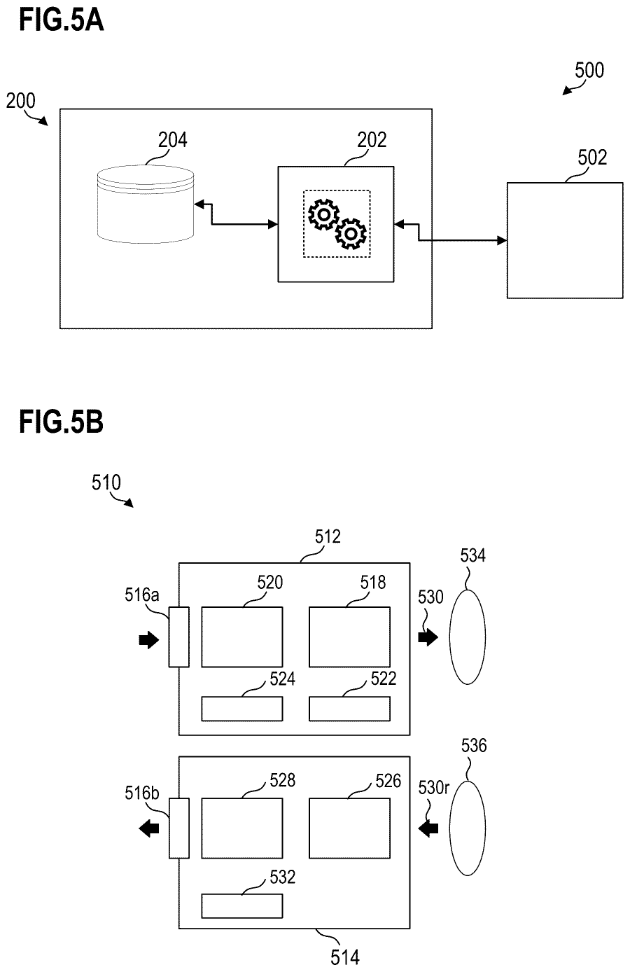

FIG. 5A shows a system 500 including the apparatus 200 and a LIDAR sensor 502 communicatively coupled with the processor 202, in a schematic representation according to various aspects. The representation in FIG. 5A is simplified for the purpose of illustration, and it is understood that the system 500 may include additional components with respect to those shown. The LIDAR sensor 502 may carry out LIDAR scans and deliver the LIDAR scans to the processor 202 for processing according to the approach described in relation to FIG. 2A to FIG. 4B (e.g., the first LIDAR scan 214, and any further LIDAR scan discussed above).

In general, the processing is carried out outside of the LIDAR sensor 502, and the LIDAR sensor 502 and the processor 202 may be communicatively coupled with one another via a communication interface. In a preferred configuration, the LIDAR sensor 502 and the processor 202 may have a direct communicative coupling, without further intervening entities therebetween other than the components responsible for “translating” the format of the data. The direct coupling ensures a faster communication and processing. In other aspects, the LIDAR sensor 502 and the processor 202 may have an indirect communicative coupling, in which the LIDAR sensor 502 transmits the LIDAR data to another entity, and the other entity then transmits the LIDAR data to the processor 202. This may enhance the flexibility of the process, by configuring the other entity to carry out additional processing functions.

In some aspects, the LIDAR sensor 502 and the processor 202 may be part of the same host. For example, considering a vehicle the processor 202 may be part of a central processing system of the vehicle, and the LIDAR sensor 502 may be mounted on the vehicle. In this scenario in which the processor 202 and the sensor 502 are in the same host, the communicative coupling may be a wired coupling, i.e., the communication interface may be configured for wired communication. For example, the LIDAR sensor 502 and the processor 202 may be coupled to a wired communication bus to exchange data and information.

In other aspects, the communicative coupling may be a wireless coupling, i.e., the communication interface may be configured for wireless communication. This configuration may be provided, for example, if the processor 202 and the LIDAR sensor 502 are not part of the same host, e.g., in case the processor 202 is located in the cloud, to carry out remote processing and then transmit back the results to the host. For example, the LIDAR sensor 502 may transmit the LIDAR scans in a wired manner to an entity within the host, and the entity may be configured to wirelessly transmit the LIDAR scans to the processor 202 at a remote location. This configuration may allow a simpler configuration for the LIDAR sensor while exploiting remote computational resources.

As mentioned above, the LIDAR sensor 502 may have any suitable configuration. FIG. 5B illustrates an exemplary LIDAR sensor 510 (e.g., an exemplary realization of the LIDAR sensor 502). In general, the LIDAR sensor 502 may operate by emitting light 530 and calculating the time it takes for the emitted light 530 to arrive back at the sensor 510 (as reflected light 530r) after hitting an object or surface in the field of view of the sensor 510. The LIDAR sensor 510 may thus be configured as a direct time-of-flight sensor. The LIDAR sensor 510 may thus include a light-emitting portion 512 for emitting the light 530, and a light-detection portion 522 for detecting the reflected light 530r. In this regard, FIG. 5B shows an exemplary and simplified representation, but it is understood that the LIDAR sensor 510 may include additional, fewer, or alternative components with respect to those shown.

For communication with external circuits (e.g., with the processor 202), the LIDAR sensor 510 may include a communication interface 516a, 516b, e.g., a first communication interface 516a for the light-emitting portion 512 and a second communication interface 516b for the light-detection portion 514, or an interface common to both portions. The communication interface 516a, 516b may be configured for wired communication or wireless communication as discussed above.

For example, the LIDAR sensor 510 may receive instructions via the first communication interface 516a, e.g., prompting the LIDAR sensor 510 to start scanning the field of view, or to stop scanning the field of view, or to change one or more scanning parameters, and the like. As another example, the LIDAR sensor 510 may transmit the results of the scanning (illustratively, the LIDAR scans) via the second communication interface 516b, e.g., as a continuous sequence of data points.

At the emitter side, the LIDAR sensor 510 may include a light source 518 configured to emit light 530, a driver circuit 520 configured to drive the light source 518, a beam steering system 522 configured to control an emission direction of the emitted light 530, and a power source 524. At the receiver side, the LIDAR sensor 510 may include a light detector 526 configured to detect the reflected light 530r, an analog frontend 528 configured to carry out analog processing of the output of the light detector 526, and a power source 532. It is understood that the LIDAR sensor 510 may alternatively include a single power source common to the emitter side and receiver side.

The light source 518 may be configured to emit light in a desired wavelength range. In particular, infrared light is commonly used for LIDAR applications, so that the light source 518 may emit light in the infrared and/or near-infrared range (e.g., from 700 nm to 5000 nm). As other examples, the light source 518 may emit light in the visible range (e.g., from 380 nm to 700 nm), or ultraviolet range (e.g., from about 100 nm to about 400 nm). In a preferred configuration, the light source 518 may be a laser source configured to emit laser light, e.g., a sequence of laser pulses. For example, the light source may include one or more vertical cavity surface emitting laser (VCSEL) diodes, e.g., an array of VCSELs.

The driver circuit 520 may be configured to control the light emission by the light source 518. For example, the driver circuit 520 may instruct the light source 518 to start emitting light, stop emitting light, change an intensity of the emitted light, change a power of the emitted light, and the like. For example, the driver circuit 520 may instruct the light source 518 to emit light according to a desired pattern, e.g., as a sequence of light pulses having a certain duration, or a certain spacing between pulses, etc.

The beam steering system 522 may be configured to control the direction of emission of the light, e.g., to scan the field of view of the LIDAR sensor 510 in one or more dimensions. As an exemplary realization, the beam steering system 522 may include one or more controllable mirrors (e.g., one or more microelectromechanical systems, MEMS, mirrors) configured to oscillate around their axis to direct the emitted light towards different directions in the field of view. As discussed in relation to FIG. 2A, as an example, the beam steering system 522 may be configured to cover any suitable angular range, e.g., a 120° field of view or a 360° field of view.

At the receiver side, the light detector 526 may be generally configured to be sensitive for the emitted light 530, i.e., the light detector 526 may be configured to detect light in the wavelength range of emission of the light source 518 (e.g., the infrared range, the visible range, the ultraviolet range). The light detector 526 may be of any suitable type. As examples, the light detector 526 may include a photo diode, e.g., an avalanche photo diode (APD), a single-photon avalanche photo diode (SPAD), a silicon photomultiplier (SiPM), and the like. As an exemplary configuration, the light detector 526 may include a two-dimensional array of pixels, to provide spatial information with the detection. As an example, a pixel may be configured as a Charged Coupled Device (CCD) or Complementary Metal Oxide Semiconductor (CMOS).

The analog frontend 528 may be configured to carry out any suitable type of analog processing. For example, the analog frontend 528 may include a transimpedance amplifier to increase the signal level of the output of the light detector 526, and to convert a current output by the light detector 526 into a corresponding voltage. As a further example, the analog frontend 528 may include a time-to-digital converter to assign a timestamp to each detection signal by the light detector 526. As a further example, the analog frontend 528 may include an analog-to-digital converter to convert the analog signals from the light detector 526 into digital signals for transmission via the communication interface 516b (and for further processing by the processor 202), etc.

The LIDAR sensor 510 may further include optical components for light emission and detection. Illustratively, the LIDAR sensor may include emitter optics 534 and receiver optics 536. The emitter optics 534 may include any suitable optical component or combination of optical components (e.g., one or more lenses, one or more objectives) for emitting light into the field of view. For example, the emitter optics 534 may be configured to collimate the emitted light 530, or to focus the emitted light 530, or to implement any suitable optical function for the emitter side. In a corresponding manner, the receiver optics 536 may include any suitable optical component or combination of optical components (e.g., one or more lenses, one or more objectives) for receiving light from the field of view. For example, the receiver optics 534 may be configured to collect the reflected light 530r, or to focus the collected light onto the light detector 526.

In some aspects, although not shown in FIG. 5B, the LIDAR sensor 510 may include additional internal motion sensors configured to detect a movement of the LIDAR sensor. The internal sensors may be configured to detect the displacement of the LIDAR sensor 510 (e.g., with respect to a reference) and transmit the results of the sensing to the processor 202, which may use the results for determining the pose of the LIDAR sensor, or for removing a distortion from a LIDAR scan, or for any other suitable purpose. For example, the LIDAR sensor 510 may include an inertial measurement sensor configured to monitor the position of the LIDAR sensor 510.

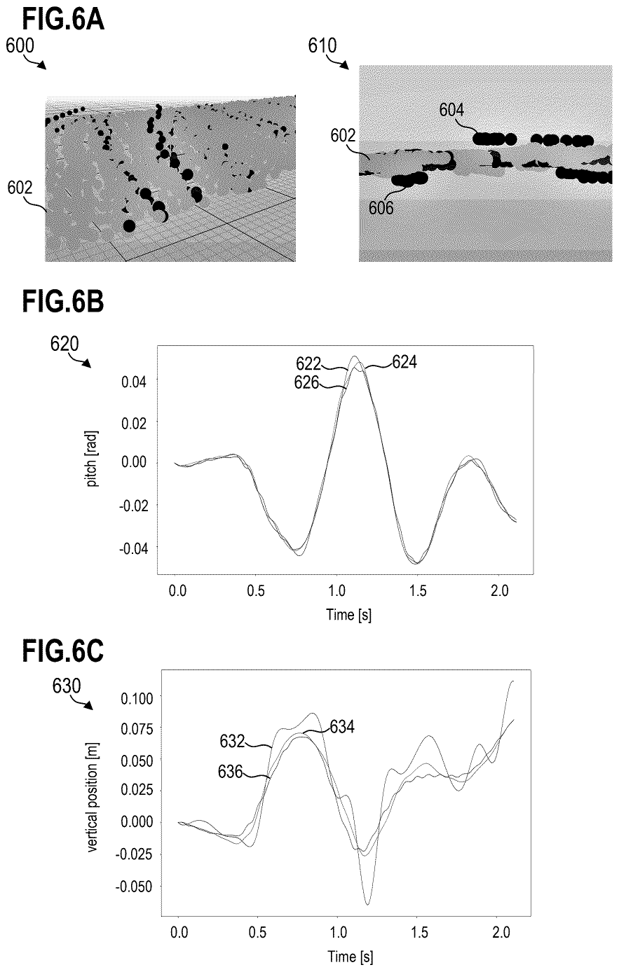

FIG. 6A to FIG. 6C show results of simulations that illustrate the advantages of the approach proposed herein with respect to conventional LIDAR egomotion.

FIG. 6A shows two graphs 600, 610 illustrating the aggregation of new data points into an existing LIDAR map. The LIDAR map includes an aggregated point cloud of data points 602 accumulated after a certain point, illustratively a static reference cloud. To the map, new data points 604 are aligned according to a conventional approach, and further new data points 606 are aligned according to the adapted approach of the present disclosure. As may be seen, in case the standard approach is used there is a mismatch between the coordinates of the new data points 604 and the reference frame of the existing data points 602. On the other hand, the strategy of the present disclosure provides an almost perfect alignment of the new data points 606 to the map.

FIG. 6B and FIG. 6C show respective graphs 620, 630 in which the results obtained via conventional LIDAR egomotion (curves 622, 632) and via the adapted egomotion of the present disclosure (curves 624, 634) are compared as reference with an inertial measurement obtained by an inertial measurement system (curves 626, 636). As may be seen, the high frequency egomotion 624,634 is on par with high frequency measurements from the inertial reference sensor (INS) 626, 636.

The graphs 620, 630 simulate the response of the pitch component and vertical position of a vehicle while going over a speed bump. The results of the naive 10 Hz LIDAR egomotion are farther off (e.g., over 3 cm) from the reference measurements that come at 100 Hz (curves 626, 636). On the other hand, the proposed new method is within millimeter accuracy to the reference measurements.

The approach of the present disclosure is thus suitable to track the egomotion even in case of high frequency maneuvers of the host. For example, a “high frequency maneuver” or “violent maneuver” may include any event above 0.1-0.2 radians/second, e.g., any event having an amplitude greater than 0.1 radians, and a frequency greater than 20 Hz, e.g., greater than 30 Hz. As mentioned, a “high frequency maneuver” or “violent maneuver” may include a sharp turn, a speed bump, a pot hole, a sudden turbulence (e.g., a gust of wind), and the like.

FIG. 7 shows a flow diagram 700 illustrating a computerized method for aligning three-dimensional (3D) detection data according to an embodiment. Referring to the examples set forth with respect to the previous drawings, method 700 may optionally be executed by the apparatus 200, e.g. according to any one of the embodiments described with reference to FIG. 2A, FIG. 3A, FIG. 4A or FIG. 5A.

In 701, a 3D model of an environment is obtained, the 3D model corresponding to a plurality of objects in the environment. This 3D model may for example be the point cloud generated from previous iterations of the following steps. By way of example, the 3D model may comprise any three-dimensional representation of the environment, including a surface-based, volumetric, feature-based, or object-level model, such as a pre-generated three-dimensional map or a High-Definition (HD) map, representing static structures in the environment. Optionally, the 3D model may be based on information derived from previous detections by the same sensor (e.g., using simultaneous localization and mapping, SLAM), from other sensors installed on the same platform (e.g., as the same vehicle), from sensors of other vehicles previously traversing the same portion of a road, or obtained in any other manner.

In 702, point cloud data including a plurality of point cloud points is obtained. Each of the point cloud points results from a 3D sensor (e.g. LIDAR) detection of a part of the environment at an instantaneous acquisition time (IAT) associated with the respective point cloud point, detection made when the 3D sensor was positioned at an instantaneous sensor position (e.g. an instantaneous sensor pose, e.g., location and orientation) associated with the respective point. By way of example, a scanning Light Detection and Ranging (LiDAR) sensor may generate on the order of tens to hundreds of thousands of point cloud points over a frame duration of several milliseconds to several tens of milliseconds, for example about 100 000 points over a frame duration of about 100 ms, such that individual point cloud points are acquired at different instantaneous acquisition times separated by microseconds to milliseconds; during this frame duration, if the sensor is mounted on a vehicle traveling at, for example, about 10 m/s, the instantaneous sensor position associated with later-acquired points may differ from that of earlier-acquired points by several millimeters or centimeters in translation, and by small changes in orientation, for example fractions of a degree, due to vehicle motion occurring between the respective instantaneous acquisition times.

As discussed later in greater detail, method 700 may be applied to detections spanning more than one frame or more than one Light Detection and Ranging (LiDAR) scan concurrently in a unified manner, for example across 10, 20, or 30 consecutive frames acquired over a duration of a few seconds; during such a duration, if the sensor is mounted on a vehicle traveling at, for example, about 10 m/s, the vehicle may traverse a distance of several meters to several tens of meters, and the orientation of the vehicle, and therefore the orientation of the LiDAR sensor, may change by several degrees, for example due to steering, road curvature, or vehicle dynamics occurring over the duration of the multiple frames.

Each detection of a respective part of the environment may include a detection of at least some of the plurality of objects, wherein the plurality of IATs spans (or is included within) a detection period (associated with the point cloud data, e.g., with the acquisition time of the point cloud data, from the earliest detection of a point cloud point in the point cloud to the last such detection). The point cloud data may include point cloud points from (e.g. only) a single sensor (e.g. LIDAR) scan or frame, from multiple frames, or even from a part of a frame. The point cloud data may include, for example, more than 10,000 point cloud points or even many more. For example, the point cloud data may include more than >10³, >10⁴, >10⁵, >10⁶, >10⁷, or more point cloud points. For example, the detection period may span 0.01-0.1 secs, 0.1-1 secs, 1-10 secs, 10-100 secs, or any other useful span of time.

The 3D sensor may move during at least part of the time that it performs sensing to obtain the 3D point cloud (possibly during the whole time). So, the detection spans a detection period comprising many instantaneous sensor positions, i.e. the point cloud contains point cloud point with many different IATs.

In 703, each point cloud point of the plurality of point cloud points is associated with two baseline time points (BTP; e.g. key time points or anchor time points) out of a plurality of at least three BTPs within the detection period. For example, a point cloud point may be associated with the BTPs whose timing are the nearest to the respective point from the entire group pf BTPs (e.g., one immediately preceding the detection timing/timestamp of the respective point cloud point, and one immediately following this detection timing). Optionally, some or all of the point cloud point of the plurality of point cloud points may be associated with more than one BTPs.

Step 703 also includes determining a weighting factor between the respective point cloud point and each of the BTPs associated to the respective point cloud point.

The weighting factors (for each point cloud point) specify, for example, a relationship between an estimated position (e.g. pose) of the 3D sensor at the respective IAT (i.e. the IAT at which the 3D sensor detection was performed from which the point cloud points results) and the estimated positions of the 3D sensor at each of the associated BTPs (i.e. the BTPs associated with the point cloud point).

For example, the weighting factors define an estimated position of the 3D sensor at the respective IAT as a function (e.g. interpolation) of estimated positions of the 3D sensor at each of the associated BTPs.

The BTPs may be sparse within the IATs of the point cloud data. For example, the ratio between the number of point cloud points and the number of BTPs is higher than 10², higher than 10³, higher than 10⁴ or higher than 5·10⁴.

The selection of BTPs withing the detection period may be done in any suitable manner, e.g., periodically (such as every 0.1sec), based on kinematic data and/or kinematic predictions (e.g., IMU data, planned path, etc.), in order to assign relatively more BTPs to times in which greater accelerations are assumed, or in any other way.

The plurality of point cloud points may include all the points acquired by the 3D sensor during the detection window or some of them. According to an embodiment, it includes all points which participate in the iterations of the iterative process (which may be seen as position (e.g. pose) estimation process) that is described in the following. Optionally, the plurality of point cloud points may include a significant portion of all point cloud points acquired by the 3D sensor during the detection period, for example >20%, >40%, >60%, >80%, >90%, >99% of all of the points detected during the detection period. Selection of only part of the acquired point cloud points, if implemented, may be performed for any suitable reason, such as to reduce computational load, to exclude points associated with noise or low confidence detections, or to focus processing on points corresponding to particular regions or structures in the environment.

Starting from initial estimates (or guesses) for the sensor positions at the BTPs, estimates for the sensor positions at the BTPs can be iteratively improved. This is for example done by minimizing an error of the matching of the point cloud points with the map: for current estimates of the sensor positions at the BTPs, position estimates for the ITAs may be calculated (e.g. by interpolating the current estimates of the sensor positions). Each data point's location (in 3D) may then be corrected according to the respective ITA's position estimate. Comparing the corrected position with the map (e.g. the data point's nearest neighbor in the map) gives rise to a matching error for the point cloud point. Aggregating those errors per point cloud point gives an error for the current estimates of the sensor positions at the BTPs. Applying an optimization algorithm to this aggregated error (or an objective function depending on it) allows iteratively improving the estimates for the sensor positions at the BTPs. An iterative process for performing this improvement of the estimates of sensor positions at the BTPs is described in the following.

In 704, an iterative process is performed (i.e. the method comprises iterating for a plurality of (i.e. sequence of) iterations, e.g. following an initial (or “starting”) iteration), wherein each iteration of the plurality of iterations (and e.g. at least partially the initial iteration, where applicable) comprises the following (steps 705 to 707).

In 705 determining an iteration-level sensor position estimation (e.g. current state or “position guess”) for each BTP of the plurality of BTPs (also denoted as “BTP sensor position estimation” or “baseline sensor position estimation”) based on an iteration correlation evaluation of a preceding iteration. The determining of step 705 may be based on the outputs of step 707 of a previous iteration. Some examples of techniques for selection of iteration-level sensor position estimations for the BTPs based on the outputs of the evaluations of step 707 are discussed below with respect to step 805 of method 800. However, any suitable selection algorithm may be used. For example, the determining of step 705 may include selecting the on-level sensor position estimation for each BTP for getting a better fit of the corrected point cloud (at step 706 below) to the 3D model, thus yielding in step 707 (below) a better evaluation of the matching between the corrected point cloud (in which the location of different points is corrected based on the iteration-level sensor position estimation of the BTPs in view of the associated weighting factors).

In 706 calculating for each point cloud point of the plurality of point cloud points an iteration-level sensor position estimation (also denoted as “point sensor position estimation”) based on (or based at least on) the iteration-level sensor position estimation determined for each of the BTPs associated with the respective point and the respective weighting factors (e.g. by interpolation of the iteration-level sensor position estimations determined for (at least some of) the BTPs, wherein the iteration-level sensor position estimations for the BTPs are weighted by the weighting factors). It should be noted that optionally, the computations of step 706 (and/or of steps 705 and/or 707) pertaining to one point cloud point of the plurality of point cloud points may be applied to a set of multiple (e.g. a batch of) point cloud points, e.g. detected within a very short time span, e.g. one microsecond. For such a batch of point cloud points, step 706 only needs to be performed for one point cloud point (representing the set). Illustratively speaking, at the end of 706, there are estimates (or “guesses”) for the position of the 3D sensor during the acquisition of each point cloud point of the plurality of point cloud points, the estimates being for example directly and unequivocally defined by the guesses of the few BTPs (e.g., in view of the weighting factors which are constant throughout the different iterations).

In 707 computing an iteration correlation evaluation based on a spatial correlation between the 3D model and the plurality of point cloud points (e.g. the 3D locations they represent) subject to spatial transformation corresponding to the plurality of iteration-level sensor position estimations for the plurality of point cloud points. This can be seen as an evaluation of the (quality of) the calculated iteration-level point sensor position estimations which in turn gives an evaluation of the BTP (or baseline) sensor position estimations.

For example, according to various embodiments, a corrected location for each point cloud point of the plurality of point cloud points is computed based on the determined iteration-level sensor position estimation determined for it in the present iteration. The corrected location of the point cloud point is a location that is represented by the point cloud point (i.e. at which the point cloud point (e.g. a surface point of one of the objects) has been detected in 3D space) that is corrected (by the spatial transformation) according to the iteration-level sensor position estimation calculated for that point cloud point.

For example, the iteration-level sensor position estimation may indicate that due to sensor movement, the location of the point cloud point (as it has been detected) should be corrected by a certain distance in a certain direction. Especially, the iteration-level sensor position estimation may optionally indicate that due to sensor movement, the existing estimated location of the point cloud point (as it has been detected and then corrected in the present iteration of step 706) should be further corrected (e.g., refining the correction) by a certain distance in a certain direction. These corrected locations (or location corrections) may then be used to compute the error of each point cloud point to its matching point in the 3D model (e.g. its nearest neighbor, e.g. determined according to ICP). These errors for the point cloud points may be (or form a basis of) the iteration correlation evaluation. The term “correlation” may be understood broadly, for example in the sense of a relationship or a degree of matching (e.g. of the 3D model (e.g. a map established so far) and the point cloud points (with their location corrected according to the iteration-level sensor position estimation). These errors may thus give a value of an objective function based on which (and e.g. its gradient) the iteration-level sensor position estimations for the BTPs for the next iteration (unless convergence has already been achieved-this may be checked at a check convergence (or check “termination”) step at this point) can be calculated, e.g. in accordance with an optimization algorithm such as Levenberg-Marquardt.

It should be noted that the BTPs are not necessarily associated to specific points of the point cloud. Therefore, the sensor estimated locations at the BTPs themselves are not necessarily needed for computing the iteration correlation evaluation (when the iteration-level sensor position estimations of the point cloud points have been determined).

It should further be noted that steps 706 and 707 can be carried out for each point individually, and possibly in a combined manner. This means that it is not necessary to perform step 706 for all point cloud points and then step 707 for all point cloud points, but 706 and 707 may be for example performed for some point cloud points and then for other point cloud points (possibly at least partially in parallel). Further, for each point cloud point, steps 706 and 707 can be executed in a single combined computation, not necessarily as one-after-the-other.

Each iteration (e.g. as long as the iterative process has not ended) may culminate with making the guesses that are used for 705 of the next iteration, i.e. for the determining of the iteration-level sensor position estimation for each BTP for the next iteration.

When the iterative process is ended (e.g. when a termination (or convergence) check has been positive), in 708, a (e.g. “corrected” or “final”) sensor position estimation for each of the plurality of point cloud points is determined based on iteration-level sensor position estimations associated with the BTPs (i.e. determined for the BTPs), e.g. associated with the respective point cloud point, of at least one iteration of the plurality of iterations (e.g. the sensor position estimations for the BTPs determined in the last iteration of the plurality of iterations). This can be simply taking the iteration-level sensor position estimations of the (e.g. last) iteration as the (corrected or final) sensor position estimation.

The (corrected or final) sensor position estimations can then be for example used for determining a (e.g. “final”) corrected location for each point cloud point of the plurality of point cloud points. These corrected locations for the point cloud points (e.g. of the surface points of objects they represent) may then (in an optional step 709) be used to update the 3D model, e.g. by mering the point cloud into the 3D model, wherein overlapping data points may be blended or averaged. The process 702 to 709 may then be repeated, e.g. in a SLAM(Simultaneous Localization and Mapping) manner.

The method of FIG. 7 can be used to estimate poses without IMU, based solely on the point cloud data itself, and can provide better results than IMU in many cases. It can be seen to be SLAM (Simultaneous Localization and Mapping)-related in the sense that, according to one embodiment, the 3D model (e.g. map) is continuously being generated from the point cloud, with the facilitating technology of assuming different “positions (e.g. poses) of acquisitions” for different points of the point cloud. According to one embodiment, this includes determining, (e.g. within a frame), a few times (e.g. the BTPs of FIG. 7) for which the estimation is required to explicitly yield a result (i.e. the sensor position estimation for (e.g. for each BTP of the plurality of BTPs)).

For example, assuming that each frame has a duration of 0.1 s, and that the method is configured to estimate of four “baseline positions” (i.e. to determine sensor position estimations for four BTPs) P1,P2,P3,P4 per frame (with P1 at T+0.0, P2 at T+0.025, P3 at T+0.05 and P4 at T+0.075). This means that the method for example gives (e.g. at the last iteration of the iterative process of FIG. 7) for each i∈{1,2,3,4} a pose estimation including an estimation of location and orientation: Pᵢ=(Xᵢ, Yᵢ, Zᵢ, θᵢ, φᵢ, ψᵢ).

Assuming a progression (e.g., linear progression of the LiDAR position and Spherical Linear Interpolation for Lidar's orientation) between two baseline positions, an interpolated pose for each point of the point cloud (e.g., 100K-300K points) can be parametrically defined as a function of its timestamp (e.g. ITA) with respect to the timestamps (e.g. BTPs) of the (temporarily) nearest two “baseline poses” (to compute the iteration-level sensor position estimation of the point cloud point as it is done in step 706).

For example, a point cloud point captured at (i.e. having an ITA of) t=T₀+0.027 is interpolated between P₂ and P₃ as Pₜ=(Xₜ_{₀}₊_{_{0·027}}, Yₜ_{₀}₊_{_{0·027}}, Zₜ_{₀}₊_{_{0·027}}, θₜ_{₀}₊_{_{0·027}}, φₜ_{₀}₊_{_{0·027}}, ψₜ_{₀}₊_{_{0·027}}), where XYZ at T₀+0.02 are for example linearly interpolated (e.g., 0.92·(X₂, Y₂, Z₂)+0.08·(X₃, Y₃, Z₃)) based on the baseline sensors position estimations made for the BTPs of times T2 and T3. and the orientation components θ, φ, ψ are for example interpolated along geodesics, e.g. using spherical linear interpolation (SLERP).

The iterative process starts with an initial iteration where there is no previous iteration from which, as in 705 (i.e. in the second, third etc. iteration) an iteration-level sensor position estimation for each BTP of the plurality of BTPs could be determined based on an iteration correlation evaluation of a preceding iteration.

Therefore, the iterative process starts in the initial iteration for example with a guess of position of each baseline position (e.g., starting by executing a standard correlation between the obtained point cloud (given by the obtained point cloud data) and the obtained (e.g. existing) 3D model (e.g. map)), for example assuming a rigid cloud (e.g. assuming that all BTPs and ITAs are the same). At each later iteration (second, third, etc.), corresponding to step 707 of the method of FIG. 7, the error of all point cloud points (e.g. the iteration correlation evaluation) is calculated. Using this evaluation, it is determined at the start of the next iteration, in 705, what should be the next guess for each baseline position. This determination can be done using an optimization algorithm like Levenberg-Marquardt).

After several iterations ending with a last iteration, there is a result for the baseline positions (sufficiently good such that the termination (or convergence) check is positive, e.g. a measure of the errors is below a threshold). From them (corresponding to step 708) the position of the sensor at each point timestamp (ITA) can be calculated using, for example, the interpolation already used before during the iterative process (e.g., t=T+0.027 between P2 and P3), where the values of P2 and P3 are the ones resulting from the last iteration.

Now that a corrected position of each point-cloud point is available, the point cloud points can be combined into the 3D model, with some (e.g. conventional) algorithm for that task. For example, e.g. as mentioned above in context of FIG. 2A, scans may be aligned and merged to provide a unified LIDAR map, wherein overlapping data points may be blended or averaged. The 3D model may optionally be updated for different types of 3D model. For example, the corrected point cloud may be used to update (e.g., correct or improve) a polygon mesh 3D model, or any other model.

Additionally or alternatively, the corrected point cloud model may be used for any other use, e.g., making a driving or navigation decision, object detection and location, and so forth.

It should be noted that in classic prior-art approaches, the alignment typically solves for a single rigid pose for the cloud (e.g., via ICP (Iterative Closest Point)), rather than solving for multiple poses within a frame/cycle. In contrast, the method of FIG. 7, according to various embodiments, solves for all of the baseline positions together.

In some embodiments, the iterative process jointly optimizes baseline positions (e.g. baseline poses) across multiple consecutive LiDAR cycles (e.g., 10-20 cycles) rather than optimizing each cycle separately, to reduce edge effects.

Since there may be many points in the point cloud (e.g., 200,000), and the approach of FIG. 7 works well even when there are as few as 1000 (for example) point cloud point detections (i.e. ITAs) between two BTPs, it is possible (by providing corresponding computational resources) to easily generate 1000 pose estimations or even 10,000 times per second, which is much higher than what an IMU-based approach can deliver. Certain use cases This may for example be useful for use cases such as certain drone uses.

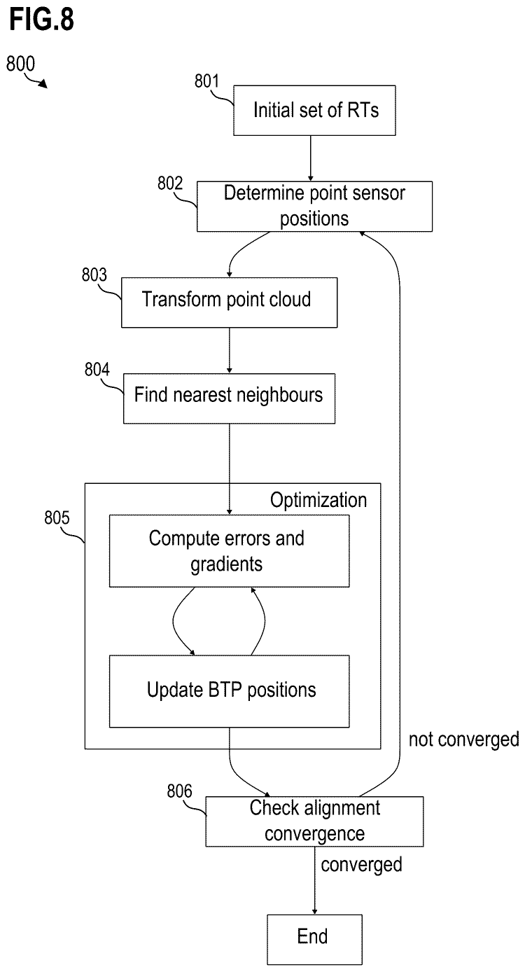

FIG. 8 shows a flow diagram 800 illustrating an example which includes the method of FIG. 7.

The method starts in 801 with an initial guess (or estimate) of the baseline positions (i.e. the sensor positions at the sensor position estimates at the BTPs). The sensor positions at the BTPs may each be represented by an indication of a location and an orientation, e.g. in form of a six DoF (degrees of freedom) pose rotation-translation 4×4 matrix (RT). The sensor positions at point cloud points other than at the BTPs may be represented in a similar manner. For example, RTs (4×4 matrixes) are calculated for each BTP and kept to serve the sensor position calculation of BTP. For each individual point cloud point (other than the BTPs) an RT (or a 4×4 matrix) is for example determined momentarily for the calculations (e.g. of the errors), so it is calculated for each point cloud point in each iteration (outer loop) and internal iteration (inner loop), but it is for example not retained for future iterations like the BTP ones.

In 802, sensor positions (e.g. poses) for each data point cloud (e.g. of the plurality of data point clouds of FIG. 7) are determined by interpolation, e.g. as described above. These for example correspond to the iteration-level sensor position estimations of step 706 for an initial iteration.

In 803, the point cloud is transformed (i.e. the 3D locations that the point cloud points represent, e.g. object surface points are transformed to get corrected locations for the point cloud points) according to the initial baseline position estimates (i.e. an initial sensor position estimation for each BTP of the plurality of BTPs).

In 804, for each point cloud point a nearest neighbor is determined in the 3D model (e.g. map) using its corrected location. A rigid transformation is then determined which, when applied to the corrected locations of all of the point cloud points, maps them to their nearest neighbors. This will not be perfectly possible and some errors will remain. For example, the rigid transformation is determined to minimize the mean squared error (between, per point cloud point, the corrected location and the location of its nearest-neighbor).

Now, in 805, the iterative process of FIG. 7 is carried out. For example, in each iteration the gradient of the error is determined, the baseline position estimates are updated (according to some optimization algorithm for reducing the error, e.g. applied to the minimization of an objective function including the error), the sensor position estimations for the data point clouds are updated, their locations are corrected according to their updated sensor position estimations and the error (and its gradient) is updated until convergence (of the respective optimization algorithm used, e.g. Levenberg-Marquardt).

So, the iterative process of FIG. 7 can be seen to form an inner loop of the flow of FIG. 8. In the iterations of the outer loop, which can be seen to be the iterations of the alignment (or registration) algorithm (e.g. ICP), it is checked in 806 whether convergence has been achieved (e.g. the mean-squared error is below a threshold). The process ends when convergence has been achieved. If convergence has not yet been achieved (or some other termination criterion is not fulfilled), the alignment algorithm goes back to 803 using the updated baseline position estimates of (the last iteration) of 805 (this can be seen as the determination of the sensor position estimation for each of the plurality of point cloud points of 708 of the method of FIG. 7).

It should be noted that in the implementation depicted in FIG. 8 a corrected location for each point cloud point is calculated twice:
once in 803, to allow calculation of the nearest neighbor in the 3D model once for this iteration (of the outer loop)
repeatedly in step 805 in order to determine the errors (e.g. used in the objective function) to iteratively update the baseline position estimates.

So, according to one embodiment, the updating of the baseline sensor position estimates, deriving the point cloud point locations accordingly and evaluating the point sensor position estimates is iterated several times based on the same nearest neighbors.

This approach may be selected because calculating nearest neighbors in step 804 is expensive computationally, so it may be preferable to only do it once per outer loop and not for each iteration of the inner loop. In context of FIG. 7, for example, for evaluating the point sensor position estimates, the nearest neighbors may for example be recalculated after a certain number of iterations. In other words, the iterative process of 704 of FIG. 7 may be distributed over multiple outer loop iterations of FIG. 8. That is, steps 803 and 804 can optionally precede steps 705, 706, and 707 within the iteration of 704.

Alternatively, the steps 803, 804, and 805 can be considered as the full iterative process of 704 (which may be repeatedly performed: once per iteration of the outer loop of FIG. 8).

An example of a stopping condition (i.e. termination criterion) for the outer loop of FIG. 8 (e.g. of a termination (e.g. convergence) check) is: were new nearest neighbors calculated in 803 in the present iteration or did 803 yield practically the same nearest neighbors as the previous iteration? The latter can be seen as an indication that the capabilities of the algorithm have been exhausted and this should be seen as convergence or a termination criterion being fulfilled.

It should be noted that if reference to a “position” is made, e.g. a sensor position), without mentioning an orientation, an orientation may also be taken into account and the processing of a position may also include processing of an orientation. So, when reference to a “position” is made in the description of a processing or operation, the processing or operation may also apply to a pose (i.e. location and orientation).

It should further be noted that a check for convergence may also be or include a check for another termination criterion, e.g. a maximum number of iterations being reached.

According to an embodiment of the method of FIG. 7, the method further comprises (after 708) updating the 3D model based on the point cloud data and the determined sensor position estimations for the plurality of point cloud points.

According to an embodiment of the method of FIG. 7, the method further comprises (after 708) making a driving decision based on the point cloud data and the determined sensor position estimations for the plurality of point cloud points.

According to an embodiment of the method of FIG. 7, the sensor position estimation for each of the plurality of point cloud points are for example determined based on the weighting factors.

According to an embodiment of the method of FIG. 7, for each point cloud point of the plurality of point cloud points and each of the BTPs associated with the point cloud point, the weighting factor is determined based on time difference between the ITA of the point cloud point and the BTP.

According to a further embodiment, an apparatus is provided configured to perform the method of FIG. 7 (in any of its embodiments).

According to a further embodiment, a non-transitory computer-readable medium is provided, comprising instructions stored thereon, that when executed on a processor, perform the method of FIG. 7 (in any of its embodiments).

The term “processor” as used herein may be understood as any kind of technological entity that allows processing data. A “processor” may be any suitable analog or digital circuit, such as a microprocessor, a graphics processing unit (GPU), a field programmable gate array (FPGA), an application specific integrated circuit (ASIC), a central processing unit (CPU), or the like.

The term “memory” as used herein may be understood as a non-transitory computer-readable medium configured to store data (e.g., instructions, measurement data, an operating system). A “memory” may be configured as volatile or non-volatile memory, e.g., as a flash memory, solid state disk, hard disk drive, random access memory (RAM), read only memory (ROM), or combinations thereof, as examples.

The phrase “at least one” and “one or more” describes a numerical quantity greater than or equal to one (e.g., one, two, three, four, . . . , etc.). Unless specified otherwise, the term “subset” in relation to a group of elements (e.g., data points) may include a numerical quantity equal to or greater than one and less than a total number of the elements.

The term “transmit” may include both direct and indirect transmission. Similarly, the term “receive” may include both direct and indirect reception.

Implementations of methods may be demonstrative in nature and may be implemented in a corresponding device. In a corresponding manner, implementations of devices or circuits may be implemented with a corresponding method. It is thus understood that a device or circuit corresponding to a method may include one or more components configured to perform each aspect of the related method.

All acronyms defined in the above description additionally hold in all claims included herein.

Various examples are given in the following.

Example 1 is an apparatus for processing data from a LIDAR sensor, the apparatus comprising a processor configured to:
obtain a LIDAR map,
wherein the LIDAR map comprises an aggregation of a plurality of LIDAR scans from a LIDAR sensor;
obtain an additional first LIDAR scan from the LIDAR sensor,
wherein the first LIDAR scan comprises a plurality of first data points; obtain pose information representative of each of a plurality of poses of the LIDAR sensor during the first LIDAR scan based on a difference between respective spatial coordinates of the first data points and reference coordinates (e.g. coordinates of surface points (e.g. of objects) in the 3D map); and
determine a rigid transformation to map each of the plurality of first data points onto the LIDAR map based on at least two adjacent poses of the plurality of poses,
wherein to determine the rigid transformation the processor is configured to, for each first data point of the plurality of first data points, determine a respective pose of the LIDAR sensor at the time of recording that first data point.

Example 2 is the apparatus according to example 1, wherein to determine the rigid transformation the processor is configured to project each first data point of the plurality of first data points onto the LIDAR map using the respective pose of the LIDAR sensor at the time of recording that first data point.

Example 3 is the apparatus according to example 1 or 2, wherein to obtain the pose information, the processor is configured to sample the pose of the LIDAR sensor at a plurality of sampling times within the first LIDAR scan.

Example 4 is the apparatus according to example 3, wherein to sample the pose of the LIDAR sensor, the processor is configured to determine the pose of the LIDAR sensor based on the first data points recorded before and/or after the sampling time of the pose.

Example 5 is the apparatus according to example 3 or 4, wherein the processor is further configured to determine, for each first data point of the plurality of first data points, the pose of the LIDAR sensor at the time of recording of that first scan point by interpolating a first pose sampled at a first sampling time before the time of recording of that first data point with a second pose sampled at a second sampling time after the time of recording of that first data point.

Example 6 is the apparatus according to any one of examples 3 to 5, wherein the processor is configured to sample the pose of the LIDAR sensor with a sampling frequency greater than a scan frequency of the LIDAR sensor.

Example 7 is the apparatus according to any one of examples 1 to 6, wherein the processor is further configured to remove a distortion of the first data points to provide an initial alignment between the first data points and the LIDAR map prior to determining the rigid transformation to map the plurality of first data points onto the LIDAR map.

Example 8 is the apparatus according to example 7, wherein the processor is configured to remove the distortion of the first data points based on motion data from a motion sensor recorded during the first LIDAR scan.

Example 9 is the apparatus according to any one of examples 1 to 8, wherein the processor is further configured to determine an egomotion of the LIDAR sensor based on the determined rigid transformation; and/or wherein the processor is further configured to determine an egomotion of a host of the LIDAR sensor based on the determined rigid transformation.

Example 10 is the apparatus according to any one of examples 1 to 9, wherein the processor is further configured to obtain a plurality of LIDAR scans from the LIDAR sensor, the plurality of LIDAR scans comprising the first LIDAR scan and one or more further LIDAR scans, wherein to obtain pose information the processor is configured to determine at least one pose of the LIDAR sensor during the first LIDAR scan based on first data points from the first LIDAR scan and on further data points from another LIDAR scan of the plurality of LIDAR scans.

Example 11 is the apparatus according to any one of examples 1 to 10, wherein the processor is further configured to use the determined rigid transformation to add the first LIDAR scan to the LIDAR map to provide an updated LIDAR map.

Example 12 is the apparatus according to example 11, wherein the processor is further configured to:
obtain an additional second LIDAR scan from the LIDAR sensor,
wherein the second LIDAR scan comprises a plurality of second data points; obtain second pose information representative of each of a plurality of second poses of the LIDAR sensor during the second LIDAR scan; and
determine a rigid transformation to map each of the plurality of second data points onto the updated LIDAR map based on at least two adjacent poses of the plurality of second poses,
wherein to determine the rigid transformation the processor is configured to determine, for each second data point of the plurality of second data points, a respective pose of the LIDAR sensor at the time of recording that second data point.

Example 13 is the apparatus according to example 12, wherein to obtain the second pose information, the processor is configured to sample the pose of the LIDAR sensor at a plurality of second sampling times during the second LIDAR scan, wherein the sampling of the pose of the LIDAR sensor during the second LIDAR scan has a different sampling frequency with respect to the sampling of the pose of the LIDAR sensor during the first LIDAR scan.

Example 14 is the apparatus of any one of examples 1 to 13, wherein the plurality of poses include up to tens of poses and the plurality of first data points includes hundreds of thousands of data points.

Example 15 is the apparatus of any one of examples 1 to 14, wherein the ratio between the number of data points of the plurality of data points and the number of poses of the plurality of poses is above thousand.

Example 16 is the apparatus of any one of examples 1 to 15,
wherein the first LIDAR scan includes point cloud data and each data point of the plurality of first data points is a point cloud point resulting from a detection by the LIDAR sensor at an instantaneous acquisition time (IAT) of a part of an environment when the LIDAR sensor was positioned at an instantaneous sensor position associated with the respective point, wherein the point cloud data includes detections of the plurality of objects, wherein the plurality of IATs span a detection period;
wherein the plurality of poses are poses of the LIDAR sensor at a plurality of at least three baseline time points (BTP);
wherein the obtaining of pose information representative of each of a plurality of poses of the LIDAR sensor during the first LIDAR scan comprises
associating each point cloud point of the plurality of point cloud points with two baseline time points (BTP) out of the plurality of BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the LIDAR map and the plurality of point cloud points subject to spatial transformation corresponding to the plurality of iteration-level sensor position estimations calculated for the plurality of point cloud points;
and wherein the at least two adjacent poses of the plurality of poses are iteration-level sensor position estimations of the two adjacent poses of at least one iteration of the plurality of iterations.

Example 17 is a method of processing data from a LIDAR sensor, the method comprising:
obtaining a LIDAR map,
wherein the LIDAR map comprises an aggregation of a plurality of LIDAR scans from a LIDAR sensor;
obtaining an additional first LIDAR scan from the LIDAR sensor,
wherein the first LIDAR scan comprises a plurality of first data points;
obtaining pose information representative of each of a plurality of poses of the LIDAR sensor during the first LIDAR scan based on a difference between respective spatial coordinates of the first data points and reference coordinates (e.g. coordinates of surface points (e.g. of objects) in the 3D map); and
determining a rigid transformation to map each of the plurality of first data points onto the LIDAR map based on at least two adjacent poses of the plurality of poses,
wherein determining the rigid transformation comprises, for each first data point of the plurality of first data points, determining a respective pose of the LIDAR sensor at the time of recording that first data point.

Example 18 is the method according to example 17, wherein to determine the rigid transformation the method comprises projecting each first data point of the plurality of first data points onto the LIDAR map using the respective pose of the LIDAR sensor at the time of recording that first data point.

Example 19 is the method according to example 17 or 18, wherein to obtain the pose information, the method comprises sampling the pose of the LIDAR sensor at a plurality of sampling times within the first LIDAR scan.

Example 20 is the method according to example 19, wherein to sample the pose of the LIDAR sensor, the method comprises determining the pose of the LIDAR sensor based on the first data points recorded before and/or after the sampling time of the pose.

Example 21 is the method according to example 19 or 20, wherein the method further comprises determining, for each first data point of the plurality of first data points, the pose of the LIDAR sensor at the time of recording of that first scan point by interpolating a first pose sampled at a first sampling time before the time of recording of that first data point with a second pose sampled at a second sampling time after the time of recording of that first data point.

Example 22 is the method according to any one of examples 19 to 21, wherein the method comprises sampling the pose of the LIDAR sensor with a sampling frequency greater than a scan frequency of the LIDAR sensor.

Example 23 is the method according to any one of examples 17 to 22, wherein the method further comprises removing a distortion of the first data points to provide an initial alignment between the first data points and the LIDAR map prior to determining the rigid transformation to map the plurality of first data points onto the LIDAR map.

Example 24 is the method according to example 23, wherein the method further comprises removing the distortion of the first data points based on motion data from a motion sensor recorded during the first LIDAR scan.

Example 25 is the method according to any one of examples 17 to 24, wherein the method further comprises determining an egomotion of the LIDAR sensor based on the determined rigid transformation; and/or wherein the method further comprises determining an egomotion of a host of the LIDAR sensor based on the determined rigid transformation.

Example 26 is the method according to any one of examples 17 to 25, wherein the method further comprises obtaining a plurality of LIDAR scans from the LIDAR sensor, the plurality of LIDAR scans comprising the first LIDAR scan and one or more further LIDAR scans, wherein to obtain pose information the method comprises determining at least one pose of the LIDAR sensor during the first LIDAR scan based on first data points from the first LIDAR scan and on further data points from another LIDAR scan of the plurality of LIDAR scans.

Example 27 is the method according to any one of examples 17 to 28, wherein the method further comprises using the determined rigid transformation to add the first LIDAR scan to the LIDAR map to provide an updated LIDAR map.

Example 28 is the method according to example 27, wherein the method further comprises: obtaining an additional second LIDAR scan from the LIDAR sensor, wherein the second LIDAR scan comprises a plurality of second data points; obtaining second pose information representative of each of a plurality of second poses of the LIDAR sensor during the second LIDAR scan; and determining a rigid transformation to map each of the plurality of second data points onto the updated LIDAR map based on at least two adjacent poses of the plurality of second poses, wherein to determine the rigid transformation the method further comprises determining, for each second data point of the plurality of second data points, a respective pose of the LIDAR sensor at the time of recording that second data point.

Example 29 is the method according to example 28, wherein to obtain the second pose information, the method comprises sampling the pose of the LIDAR sensor at a plurality of second sampling times during the second LIDAR scan, wherein the sampling of the pose of the LIDAR sensor during the second LIDAR scan has a different sampling frequency with respect to the sampling of the pose of the LIDAR sensor during the first LIDAR scan.

Example 30 is the method of any one of examples 17 to 29, wherein the plurality of poses include up to tens of poses and the plurality of first data points includes hundreds of thousands of data points.

Example 31 is the method of any one of examples 17 to 30, wherein the ratio between the number of data points of the plurality of data points and the number of poses of the plurality of poses is above thousand.

Example 32 is the method of any one of examples 17 to 31,
wherein the first LIDAR scan includes point cloud data and each data point of the plurality of first data points is a point cloud point resulting from a detection by the LIDAR sensor at an instantaneous acquisition time (IAT) of a part of an environment when the LIDAR sensor was positioned at an instantaneous sensor position associated with the respective point, wherein the point cloud data includes detections of the plurality of objects, wherein the plurality of IATs span a detection period;
wherein the plurality of poses are poses of the LIDAR sensor at a plurality of at least three baseline time points (BTP);
wherein the obtaining of pose information representative of each of a plurality of poses of the LIDAR sensor during the first LIDAR scan comprises
associating each point cloud point of the plurality of point cloud points with two baseline time points (BTP) out of the plurality of BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the LIDAR map and the plurality of point cloud points subject to spatial transformation corresponding to the plurality of iteration-level sensor position estimations calculated for the plurality of point cloud points;
and wherein the at least two adjacent poses of the plurality of poses are iteration-level sensor position estimations of the two adjacent poses of at least one iteration of the plurality of iterations.

Example 33 is a non-transitory computer-readable medium, comprising instructions stored thereon, that when executed on a processor, perform a method of processing data from a LIDAR sensor, the method comprising:
obtaining a LIDAR map,
wherein the LIDAR map comprises an aggregation of a plurality of LIDAR scans from a LIDAR sensor;
obtaining an additional first LIDAR scan from the LIDAR sensor,
wherein the first LIDAR scan comprises a plurality of first data points;
obtaining pose information representative of each of a plurality of poses of the LIDAR sensor during the first LIDAR scan based on a difference between respective spatial coordinates of the first data points and reference coordinates (e.g. coordinates of surface points (e.g. of objects) in the 3D map); and
determining a rigid transformation to map each of the plurality of first data points onto the LIDAR map based on at least two adjacent poses of the plurality of poses,
wherein determining the rigid transformation comprises, for each first data point of the plurality of first data points, determining a respective pose of the LIDAR sensor at the time of recording that first data point.

Example 34 is the non-transitory computer-readable medium according to example 33, wherein to determine the rigid transformation the method comprises projecting each first data point of the plurality of first data points onto the LIDAR map using the respective pose of the LIDAR sensor at the time of recording that first data point.

Example 35 is the non-transitory computer-readable medium according to example 33 or 34, wherein to obtain the pose information, the method comprises sampling the pose of the LIDAR sensor at a plurality of sampling times within the first LIDAR scan.

Example 36 is the non-transitory computer-readable medium according to example 35, wherein to sample the pose of the LIDAR sensor, the method comprises determining the pose of the LIDAR sensor based on the first data points recorded before and/or after the sampling time of the pose.

Example 37 is the non-transitory computer-readable medium according to example 35 or 36, wherein the method further comprises determining, for each first data point of the plurality of first data points, the pose of the LIDAR sensor at the time of recording of that first scan point by interpolating a first pose sampled at a first sampling time before the time of recording of that first data point with a second pose sampled at a second sampling time after the time of recording of that first data point.

Example 38 is the non-transitory computer-readable medium according to any one of examples 35 to 37, wherein the method comprises sampling the pose of the LIDAR sensor with a sampling frequency greater than a scan frequency of the LIDAR sensor.

Example 39 is the non-transitory computer-readable medium according to any one of examples 33 to 38, wherein the method further comprises removing a distortion of the first data points to provide an initial alignment between the first data points and the LIDAR map prior to determining the rigid transformation to map the plurality of first data points onto the LIDAR map.

Example 40 is the non-transitory computer-readable medium according to example 39, wherein the method further comprises removing the distortion of the first data points based on motion data from a motion sensor recorded during the first LIDAR scan.

Example 41 is the non-transitory computer-readable medium according to any one of examples 33 to 40, wherein the method further comprises determining an egomotion of the LIDAR sensor based on the determined rigid transformation; and/or wherein the method further comprises determining an egomotion of a host of the LIDAR sensor based on the determined rigid transformation.

Example 42 is the non-transitory computer-readable medium according to any one of examples 33 to 41, wherein the method further comprises obtaining a plurality of LIDAR scans from the LIDAR sensor, the plurality of LIDAR scans comprising the first LIDAR scan and one or more further LIDAR scans, wherein to obtain pose information the method comprises determining at least one pose of the LIDAR sensor during the first LIDAR scan based on first data points from the first LIDAR scan and on further data points from another LIDAR scan of the plurality of LIDAR scans.

Example 43 is the non-transitory computer-readable medium according to any one of examples 33 to 42, wherein the method further comprises using the determined rigid transformation to add the first LIDAR scan to the LIDAR map to provide an updated LIDAR map.

Example 44 is the non-transitory computer-readable medium according to example 43, wherein the method further comprises:
obtaining an additional second LIDAR scan from the LIDAR sensor,
wherein the second LIDAR scan comprises a plurality of second data points;
obtaining second pose information representative of each of a plurality of second poses of the LIDAR sensor during the second LIDAR scan; and
determining a rigid transformation to map each of the plurality of second data points onto the updated LIDAR map based on at least two adjacent poses of the plurality of second poses,
wherein to determine the rigid transformation the method further comprises determining, for each second data point of the plurality of second data points, a respective pose of the LIDAR sensor at the time of recording that second data point.

Example 45 is the non-transitory computer-readable medium according to example 44, wherein to obtain the second pose information, the method comprises sampling the pose of the LIDAR sensor at a plurality of second sampling times during the second LIDAR scan,
wherein the sampling of the pose of the LIDAR sensor during the second LIDAR scan has a different sampling frequency with respect to the sampling of the pose of the LIDAR sensor during the first LIDAR scan.

Example 46 is the non-transitory computer-readable medium of any one of examples 33 to 45, wherein the plurality of poses include up to tens of poses and the plurality of first data points includes hundreds of thousands of data points.

Example 47 is the non-transitory computer-readable medium of any one of examples 33 to 46, wherein the ratio between the number of data points of the plurality of data points and the number of poses of the plurality of poses is above thousand.

Example 48 is the non-transitory computer-readable medium of any one of examples 33 to 47,
wherein the first LIDAR scan includes point cloud data and each data point of the plurality of first data points is a point cloud point resulting from a detection by the LIDAR sensor at an instantaneous acquisition time (IAT) of a part of an environment when the LIDAR sensor was positioned at an instantaneous sensor position associated with the respective point, wherein the point cloud data includes detections of the plurality of objects, wherein the plurality of IATs span a detection period;
wherein the plurality of poses are poses of the LIDAR sensor at a plurality of at least three baseline time points (BTP);
wherein the obtaining of pose information representative of each of a plurality of poses of the LIDAR sensor during the first LIDAR scan comprises
associating each point cloud point of the plurality of point cloud points with two baseline time points (BTP) out of the plurality of BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the LIDAR map and the plurality of point cloud points subject to spatial transformation corresponding to the plurality of iteration-level sensor position estimations calculated for the plurality of point cloud points;
and wherein the at least two adjacent poses of the plurality of poses are iteration-level sensor position estimations of the two adjacent poses of at least one iteration of the plurality of iterations.

Example 49 is an apparatus for processing data from a LIDAR sensor, the apparatus comprising a processor configured to align three-dimensional (3D) detection data by obtaining a 3D model of an environment, the 3D model corresponding to a plurality of objects in the environment;
obtaining point cloud data including a plurality of point cloud points, each of the point cloud points resulting from a 3D sensor detection at an instantaneous acquisition time (IAT) of a part of the environment when the 3D sensor was positioned at an instantaneous sensor position associated with the respective point, wherein the point cloud data includes detections of the plurality of objects, wherein the plurality of IATs span a detection period;
associating each point cloud point of the plurality of point cloud points with two baseline time points (BTP) out of a plurality of at least three BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the 3D model and the plurality of point cloud points subject to spatial transformation corresponding to the plurality of iteration-level sensor position estimations calculated for the plurality of point cloud points;
and determine a sensor position estimation for each of the plurality of point cloud points based on iteration-level sensor position estimations associated with the BTPs associated with the respective point cloud point of at least one iteration of the plurality of iterations.

Example 50 is the apparatus according to example 49, wherein the iterating comprises at a first iteration,
determining for each of the BTPs a first iteration-level sensor position estimation, calculating for each point cloud point of the plurality of point cloud points a first iteration-level sensor position estimation based on the iteration-level sensor position estimation determined for each of the BTPs associated with the respective point cloud point and the respective weighting factors,
computing a first iteration correlation evaluation based on a spatial correlation between the 3D model and the plurality of point cloud points subject to spatial transformation corresponding to the plurality of first iteration-level sensor position estimations calculated for the plurality of point cloud points;
determining that the first iteration correlation evaluation does not meet a termination (e.g. quality) criterion (e.g. the estimates of the locations of the lidar at the BTPs are not good enough and should be adjusted),
in reaction to the determining that the first iteration correlation evaluation does not meet the termination (e.g. quality) criterion, at a second iteration,
determining for each of the BTPs a second iteration-level sensor position estimation, such that at least one of the second iteration-level sensor position estimations is different from the first iteration-level sensor position estimations,
calculating for each point cloud point of the plurality of point cloud points a second iteration-level sensor position estimation based on the iteration-level sensor position estimation determined for each of the BTPs associated with the respective point cloud point and the respective weighting factors,
computing a second iteration correlation evaluation based on a spatial correlation between the 3D model and the plurality of point cloud points subject to spatial transformation corresponding to the plurality of second iteration-level sensor position estimations calculated for the plurality of point cloud points;
determining that the second iteration correlation evaluation does meet the termination criterion, and,
in reaction to the determining that the second iteration correlation evaluation does meet the termination criterion, at a second iteration, terminating the iterating.

It should be noted that these two iterations may be the last two iterations, the iterative process may include more iterations such that the “first” iteration is for example the n-1th iteration and the second iteration is the nth iteration when the iterative process is ended.

Example 51 is the apparatus of example 50, wherein the selecting of the second iteration-level position for each BTP is based on data consisting of the first iteration correlation evaluation, the point cloud data, the plurality of point cloud points and the 3D model.

Example 52 is the apparatus of example 16 or any one of examples 49 to 51, wherein the processor is further configured to update the 3D model based on the point cloud data and the determined sensor position estimations for the plurality of point cloud points.

Example 53 is the apparatus of example 16 or any one of examples 49 to 52, wherein the processor is further configured to make a driving decision based on the point cloud data and the determined sensor position estimations for the plurality of point cloud points.

Example 54 is the apparatus of example 16 or any one of examples 49 to 53, wherein the processor is configured to determine the sensor position estimation for each of the plurality of point cloud points based on the weighting factors.

Example 55 is the apparatus of example 16 or any one of examples 49 to 54, wherein the processor is further configured to, for each point cloud point of the plurality of point cloud points and each of the BTPs associated with the point cloud point, determine the weighting factor based on time differences between the ITA of the point cloud point and the associated BTPs.

Example 56 is the apparatus of example 16 or any one of examples 49 to 55, wherein the processor is further configured to associate each point cloud point of the plurality of point cloud points with two baseline time points (BTP) out of the plurality of BTPs which are closest to the IAT of the point cloud point.

Example 57 is the apparatus of example 16 or any one of examples 49 to 56, wherein the processor is further configured to determine at least one of an egomotion of the 3D sensor and an egomotion of a host of the 3D sensor based on the sensor position estimations determined for the plurality of point cloud points.

Example 58 is a computerized method for aligning three-dimensional (3D) detection data, the method comprising:
obtaining a 3D model of an environment, the 3D model corresponding to a plurality of objects in the environment;
obtaining point cloud data including a plurality of point cloud points, each of the point cloud points resulting from a 3D sensor detection at an instantaneous acquisition time (IAT) of a part of the environment when the 3D sensor was positioned at an instantaneous sensor position associated with the respective point, wherein the point cloud data includes detections of the plurality of objects, wherein the plurality of IATs span a detection period;
associating each point cloud point of the plurality of point cloud points with two baseline time points (BTP) out of a plurality of at least three BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the 3D model and the plurality of point cloud points subject to spatial transformation corresponding to the plurality of iteration-level sensor position estimations calculated for the plurality of point cloud points; and
determine a sensor position estimation for each of the plurality of point cloud points based on iteration-level sensor position estimations associated with the BTPs associated with the respective point cloud point of at least one iteration of the plurality of iterations.

Example 59 is the method according to example 58, wherein the iterating comprises at a first iteration,
determining for each of the BTPs a first iteration-level sensor position estimation, calculating for each point cloud point of the plurality of point cloud points a first iteration-level sensor position estimation based on the iteration-level sensor position estimation determined for each of the BTPs associated with the respective point cloud point and the respective weighting factors,
computing a first iteration correlation evaluation based on a spatial correlation between the 3D model and the plurality of point cloud points subject to spatial transformation corresponding to the plurality of first iteration-level sensor position estimations calculated for the plurality of point cloud points;
determining that the first iteration correlation evaluation does not meet a termination (e.g. quality) criterion (e.g. the estimates of the locations of the lidar at the BTPs are not good enough and should be adjusted),
in reaction to the determining that the first iteration correlation evaluation does not meet the termination (e.g. quality) criterion, at a second iteration,
determining for each of the BTPs a second iteration-level sensor position estimation, such that at least one of the second iteration-level sensor position estimations is different from the first iteration-level sensor position estimations,
calculating for each point cloud point of the plurality of point cloud points a second iteration-level sensor position estimation based on the iteration-level sensor position estimation determined for each of the BTPs associated with the respective point cloud point and the respective weighting factors,
computing a second iteration correlation evaluation based on a spatial correlation between the 3D model and the plurality of point cloud points subject to spatial transformation corresponding to the plurality of second iteration-level sensor position estimations calculated for the plurality of point cloud points;
determining that the second iteration correlation evaluation does meet the termination criterion, and,
in reaction to the determining that the second iteration correlation evaluation does meet the termination criterion, at a second iteration, terminating the iterating.

It should be noted that these two iterations may be the last two iterations, the iterative process may include more iterations such that the “first” iteration is for example the n-1th iteration and the second iteration is the nth iteration when the iterative process is ended.

Example 60 is the method of example 59, wherein the selecting of the second iteration-level position for each BTP is based on data consisting of the first iteration correlation evaluation, the point cloud data, the plurality of point cloud points and the 3D model.

Example 61 is the method of example 32 or any one of examples 58 to 60, further comprising updating the 3D model based on the point cloud data and the determined sensor position estimations for the plurality of point cloud points.

Example 62 is the method of example 32 or any one of examples 58 to 61, further comprising making a driving decision based on the point cloud data and the determined sensor position estimations for the plurality of point cloud points.

Example 63 is the method of example 32 or any one of examples 58 to 62, wherein the sensor position estimation for each of the plurality of point cloud points are determined based on the weighting factors.

Example 64 is the method of example 32 or any one of examples 58 to 63, wherein, for each point cloud point of the plurality of point cloud points and each of the BTPs associated with the point cloud point, the weighting factor is determined based on time differences between the ITA of the point cloud point and the associated BTPs.

Example 65 is the method of example 32 or any one of examples 58 to 64, wherein each point cloud point of the plurality of point cloud points is associated with two baseline time points (BTP) out of the plurality of BTPs which are closest to the IAT of the point cloud point.

Example 66 is the method of example 32 or any one of examples 58 to 65, further comprising determining at least one of an egomotion of the 3D sensor and an egomotion of a host of the 3D sensor based on the sensor position estimations determined for the plurality of point cloud points.

Example 67 is a non-transitory computer-readable medium, comprising instructions stored thereon, that when executed on a processor, perform a computerized method for aligning three-dimensional (3D) detection data, the method comprising:
obtaining a 3D model of an environment, the 3D model corresponding to a plurality of objects in the environment;
obtaining point cloud data including a plurality of point cloud points, each of the point cloud points resulting from a 3D sensor detection at an instantaneous acquisition time (IAT) of a part of the environment when the 3D sensor was positioned at an instantaneous sensor position associated with the respective point, wherein the point cloud data includes detections of the plurality of objects, wherein the plurality of IATs span a detection period;
associating each point cloud point of the plurality of point cloud points with two baseline time points (BTP) out of a plurality of at least three BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the 3D model and the plurality of point cloud points subject to spatial transformation corresponding to the plurality of iteration-level sensor position estimations calculated for the plurality of point cloud points; and determine a sensor position estimation for each of the plurality of point cloud points based on iteration-level sensor position estimations associated with the BTPs associated with the respective point cloud point of at least one iteration of the plurality of iterations.

Example 68 is the non-transitory computer-readable medium according to example 69, wherein the iterating comprises
at a first iteration,
determining for each of the BTPs a first iteration-level sensor position estimation, calculating for each point cloud point of the plurality of point cloud points a first iteration-level sensor position estimation based on the iteration-level sensor position estimation determined for each of the BTPs associated with the respective point cloud point and the respective weighting factors,
computing a first iteration correlation evaluation based on a spatial correlation between the 3D model and the plurality of point cloud points subject to spatial transformation corresponding to the plurality of first iteration-level sensor position estimations calculated for the plurality of point cloud points;
determining that the first iteration correlation evaluation does not meet a termination (e.g. quality) criterion (e.g. the estimates of the locations of the lidar at the BTPs are not good enough and should be adjusted),
in reaction to the determining that the first iteration correlation evaluation does not meet the termination (e.g. quality) criterion, at a second iteration,
determining for each of the BTPs a second iteration-level sensor position estimation, such that at least one of the second iteration-level sensor position estimations is different from the first iteration-level sensor position estimations,
calculating for each point cloud point of the plurality of point cloud points a second iteration-level sensor position estimation based on the iteration-level sensor position estimation determined for each of the BTPs associated with the respective point cloud point and the respective weighting factors,
computing a second iteration correlation evaluation based on a spatial correlation between the 3D model and the plurality of point cloud points subject to spatial transformation corresponding to the plurality of second iteration-level sensor position estimations calculated for the plurality of point cloud points;
determining that the second iteration correlation evaluation does meet the termination criterion, and,
in reaction to the determining that the second iteration correlation evaluation does meet the termination criterion, at a second iteration, terminating the iterating.

It should be noted that these two iterations may be the last two iterations, the iterative process may include more iterations such that the “first” iteration is for example the n-1th iteration and the second iteration is the nth iteration when the iterative process is ended.

Example 69 is the non-transitory computer-readable medium of example 68, wherein the selecting of the second iteration-level position for each BTP is based on data consisting of the first iteration correlation evaluation, the point cloud data, the plurality of point cloud points and the 3D model.

Example 70 is the non-transitory computer-readable medium of example 48 or any one of examples 67 to 69, further comprising updating the 3D model based on the point cloud data and the determined sensor position estimations for the plurality of point cloud points.

Example 71 is the non-transitory computer-readable medium of example 48 or any one of examples 67 to 70, further comprising making a driving decision based on the point cloud data and the determined sensor position estimations for the plurality of point cloud points.

Example 72 is the non-transitory computer-readable medium of example 48 or any one of examples 67 to 71, wherein the sensor position estimation for each of the plurality of point cloud points are determined based on the weighting factors.

Example 73 is the non-transitory computer-readable medium of example 48 or any one of examples 67 to 72, wherein, for each point cloud point of the plurality of point cloud points and each of the BTPs associated with the point cloud point, the weighting factor is determined based on time differences between the ITA of the point cloud point and the associated BTPs.

Example 74 is the non-transitory computer-readable medium of example 48 or any one of examples 67 to 73, wherein each point cloud point of the plurality of point cloud points is associated with two baseline time points (BTP) out of the plurality of BTPs which are closest to the IAT of the point cloud point.

Example 75 is the non-transitory computer-readable medium of example 48 or any one of examples 67 to 74, further comprising determining at least one of an egomotion of the 3D sensor and an egomotion of a host of the 3D sensor based on the sensor position estimations determined for the plurality of point cloud points.

While the invention has been particularly shown and described with reference to specific aspects, it should be understood that various changes in form and detail may be made therein without departing from the scope of the invention as defined by the appended claims.

1. An apparatus for processing data from a LIDAR sensor, the apparatus comprising a processor configured to align three-dimensional (3D) detection data by
obtaining a 3D model of an environment, the 3D model corresponding to a plurality of objects in the environment;
obtaining point cloud data including a plurality of point cloud points, each of the point cloud points resulting from a 3D sensor detection at an instantaneous acquisition time (IAT) of a part of the environment when the 3D sensor was positioned at an instantaneous sensor position associated with the respective point, wherein the point cloud data includes detections of the plurality of objects, wherein the plurality of IATs span a detection period;
associating each point cloud point of the plurality of point cloud points with two baseline time points (BTP) out of a plurality of at least three BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the 3D model and the plurality of point cloud points subject to spatial transformation corresponding to the plurality of iteration-level sensor position estimations calculated for the plurality of point cloud points;
and determine a sensor position estimation for each of the plurality of point cloud points based on iteration-level sensor position estimations associated with the BTPs associated with the respective point cloud point of at least one iteration of the plurality of iterations.

2. The apparatus according to claim 1, wherein the iterating comprises
at a first iteration,
determining for each of the BTPs a first iteration-level sensor position estimation, calculating for each point cloud point of the plurality of point cloud points a first iteration-level sensor position estimation based on the iteration-level sensor position estimation determined for each of the BTPs associated with the respective point cloud point and the respective weighting factors,
computing a first iteration correlation evaluation based on a spatial correlation between the 3D model and the plurality of point cloud points subject to spatial transformation corresponding to the plurality of first iteration-level sensor position estimations calculated for the plurality of point cloud points;
determining that the first iteration correlation evaluation does not meet a termination criterion, in reaction to the determining that the first iteration correlation evaluation does not meet the termination criterion, at a second iteration,
determining for each of the BTPs a second iteration-level sensor position estimation, such that at least one of the second iteration-level sensor position estimations is different from the first iteration-level sensor position estimations,
calculating for each point cloud point of the plurality of point cloud points a second iteration-level sensor position estimation based on the iteration-level sensor position estimation determined for each of the BTPs associated with the respective point cloud point and the respective weighting factors,
computing a second iteration correlation evaluation based on a spatial correlation between the 3D model and the plurality of point cloud points subject to spatial transformation corresponding to the plurality of second iteration-level sensor position estimations calculated for the plurality of point cloud points;
determining that the second iteration correlation evaluation does meet the termination criterion, and,
in reaction to the determining that the second iteration correlation evaluation does meet the termination criterion, at a second iteration, terminating the iterating.

3. The apparatus of claim 2, wherein the selecting of the second iteration-level position for each BTP is based on data consisting of the first iteration correlation evaluation, the point cloud data, the plurality of point cloud points and the 3D model.

4. The apparatus of claim 1, wherein the processor is further configured to update the 3D model based on the point cloud data and the determined sensor position estimations for the plurality of point cloud points.

5. The apparatus of claim 1, wherein the processor is further configured to make a driving decision based on the point cloud data and the determined sensor position estimations for the plurality of point cloud points.

6. The apparatus of claim 1, wherein the processor is configured to determine the sensor position estimation for each of the plurality of point cloud points based on the weighting factors.

7. The apparatus of claim 1, wherein the processor is further configured to, for each point cloud point of the plurality of point cloud points and each of the BTPs associated with the point cloud point, determine the weighting factor based on time differences between the ITA of the point cloud point and the associated BTPs.

8. The apparatus of claim 1, wherein the processor is further configured to associate each point cloud point of the plurality of point cloud points with two BTPs out of the plurality of BTPs which are closest to the IAT of the point cloud point.

9. The apparatus of claim 1, wherein the processor is further configured to determine at least one of an egomotion of the 3D sensor and an egomotion of a host of the 3D sensor based on the sensor position estimations determined for the plurality of point cloud points.

10. A computerized method for aligning three-dimensional (3D) detection data, the method comprising:
obtaining a 3D model of an environment, the 3D model corresponding to a plurality of objects in the environment;
obtaining point cloud data including a plurality of point cloud points, each of the point cloud points resulting from a 3D sensor detection at an instantaneous acquisition time (IAT) of a part of the environment when the 3D sensor was positioned at an instantaneous sensor position associated with the respective point, wherein the point cloud data includes detections of the plurality of objects, wherein the plurality of IATs span a detection period;
associating each point cloud point of the plurality of point cloud points with two baseline time points (BTP) out of a plurality of at least three BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the 3D model and the plurality of point cloud points subject to spatial transformation corresponding to the plurality of iteration-level sensor position estimations calculated for the plurality of point cloud points;
and determine a sensor position estimation for each of the plurality of point cloud points based on iteration-level sensor position estimations associated with the BTPs associated with the respective point cloud point of at least one iteration of the plurality of iterations.

11. The method of claim 10, further comprising updating the 3D model based on the point cloud data and the determined sensor position estimations for the plurality of point cloud points.

12. The method of claim 10, wherein the sensor position estimation for each of the plurality of point cloud points are determined based on the weighting factors.

13. The method of claim 10, wherein, for each point cloud point of the plurality of point cloud points and each of the BTPs associated with the point cloud point, the weighting factor is determined based on time differences between the ITA of the point cloud point and the associated BTPs.

14. The method of claim 10, wherein each point cloud point of the plurality of point cloud points is associated with two BTPs out of the plurality of BTPs which are closest to the IAT of the point cloud point.

15. A non-transitory computer-readable medium, comprising instructions stored thereon, that when executed on a processor, perform a computerized method for aligning three-dimensional (3D) detection data, the method comprising:
obtaining a 3D model of an environment, the 3D model corresponding to a plurality of objects in the environment;
obtaining point cloud data including a plurality of point cloud points, each of the point cloud points resulting from a 3D sensor detection at an instantaneous acquisition time (IAT) of a part of the environment when the 3D sensor was positioned at an instantaneous sensor position associated with the respective point, wherein the point cloud data includes detections of the plurality of objects, wherein the plurality of IATs span a detection period;
associating each point cloud point of the plurality of point cloud points with two baseline time points (BTP) out of a plurality of at least three BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the 3D model and the plurality of point cloud points subject to spatial transformation corresponding to the plurality of iteration-level sensor position estimations calculated for the plurality of point cloud points;
and determine a sensor position estimation for each of the plurality of point cloud points based on iteration-level sensor position estimations associated with the BTPs associated with the respective point cloud point of at least one iteration of the plurality of iterations.

16. The non-transitory computer-readable medium of claim 15, wherein the sensor position estimation for each of the plurality of point cloud points are determined based on the weighting factors.

17. The non-transitory computer-readable medium of claim 15, wherein, for each point cloud point of the plurality of point cloud points and each of the BTPs associated with the point cloud point, the weighting factor is determined based on time differences between the ITA of the point cloud point and the associated BTPs.

18. The non-transitory computer-readable medium of claim 15, wherein each point cloud point of the plurality of point cloud points is associated with two BTPs out of the plurality of BTPs which are closest to the IAT of the point cloud point.

19. An apparatus for processing data from a LIDAR sensor, the apparatus comprising a processor configured to:
obtain a LIDAR map,
wherein the LIDAR map comprises an aggregation of a plurality of LIDAR scans from a LIDAR sensor;
obtain an additional first LIDAR scan from the LIDAR sensor,
wherein the first LIDAR scan comprises a plurality of first data points;
obtain pose information representative of each of a plurality of poses of the LIDAR sensor during the first LIDAR scan based on a difference between respective spatial coordinates of the first data points and reference coordinates; and
determine a rigid transformation to map each of the plurality of first data points onto the LIDAR map based on at least two adjacent poses of the plurality of poses,
wherein to determine the rigid transformation the processor is configured to, for each first data point of the plurality of first data points, determine a respective pose of the LIDAR sensor at the time of recording that first data point.

20. The apparatus of claim 19, wherein the plurality of poses include up to tens of poses and the plurality of first data points includes hundreds of thousands of data points.

21. The apparatus of claim 19, wherein the ratio between the number of data points of the plurality of data points and the number of poses of the plurality of poses is above thousand.

22. The apparatus of claim 19,
wherein the first LIDAR scan includes point cloud data and each data point of the plurality of first data points is a point cloud point resulting from a detection by the LIDAR sensor at an instantaneous acquisition time (IAT) of a part of an environment when the LIDAR sensor was positioned at an instantaneous sensor position associated with the respective point, wherein the point cloud data includes detections of the plurality of objects, wherein the plurality of IATs span a detection period;
wherein the plurality of poses are poses of the LIDAR sensor at a plurality of at least three baseline time points (BTP);
wherein the obtaining of pose information representative of each of a plurality of poses of the LIDAR sensor during the first LIDAR scan comprises
associating each point cloud point of the plurality of point cloud points with two BTPs out of the plurality of BTPs within the detection period, and determining a weighting factor between the respective point cloud point and each of the BTPs associated to the respective point cloud point;
iterating for a plurality of iterations:
determine an iteration-level sensor position estimation for each BTP of the plurality of BTPs based on an iteration correlation evaluation of a preceding iteration;
calculate for each point cloud point of the plurality of point cloud points an iteration-level sensor position estimation based on the iteration-level sensor position estimation determined for each of the BTPs associated with the respective point cloud point and the respective weighting factors;
compute an iteration correlation evaluation based on a spatial correlation between the LIDAR map and the plurality of point cloud points subject to spatial transformation corresponding to the plurality of iteration-level sensor position estimations calculated for the plurality of point cloud points;
and wherein the at least two adjacent poses of the plurality of poses are iteration-level sensor position estimations of the two adjacent poses of at least one iteration of the plurality of iterations.
